(19) United States
(12) Patent Application Publication
(10) Pub. No.: US 2025/0358300 A1
(43) Pub. Date: Nov. 20, 2025

(54) ML BASED DOMAIN RISK SCORING AND ITS APPLICATIONS TO ADVANCED URL FILTERING

(71) Applicant: Palo Alto Networks, Inc., Santa Clara, CA (US)

(72) Inventors: Mohamed Yoosuf Mohamed Nabeel, San Jose, CA (US); William Russell Melicher, Sunnyvale, CA (US); Oleksii Starov, Sunnyvale, CA (US); Zhenhua Chen, Milpitas, CA (US)

(21) Appl. No.: 18/667,982

(22) Filed: May 17, 2024

(51) Int. Cl. H04L 9/40

(52) U.S. Cl. CPC H04L 63/1425; H04L 63/1416

(57) ABSTRACT

The present application discloses a method, system, and computer system for providing real-time detection of malicious URLs based on a machine-learning powered domain risk scoring. The method includes (i) identifying a subset of higher risk websites, wherein the higher risk websites are at risk for potential malware injection or modification, and (ii) in response to identifying the subset of higher risk websites, performing an active measure based at least in part on the identified subset of higher risk websites.

### BACKGROUND OF THE INVENTION

Nefarious individuals attempt to compromise computer systems in a variety of ways. As one example, such individuals may embed or otherwise include malicious software (“malware”) in email attachments and transmit or cause the malware to be transmitted to unsuspecting users. As another example, such individuals may input command strings such as SQL input strings, etc., that cause a remote host to execute such command strings. As another example, such individuals develop webpages that host malware or other malicious content. The malware or other malicious content can turn a compromised computer into a “bot” in a “botnet,” receiving instructions from and/or reporting data to a command and control (C&C) server under the control of the nefarious individual. One approach to mitigating the damage caused by exploit tools (e.g., malware, malicious command strings, etc.) is for a security company (or other appropriate entity) to attempt to identify malicious websites distributing the exploit tools and prevent the malicious websites from distributing the exploit tools to end user computers. Another approach is to try to prevent compromised computers from communicating with the C&C server. Unfortunately, malicious authors are using increasingly sophisticated techniques to obfuscate the workings of their exploit tools. Accordingly, there exists an ongoing need for improved techniques to detect malware or exploits and prevent their harm.

### BRIEF DESCRIPTION OF THE DRA WINGS

Various embodiments of the invention are disclosed in the following detailed description and the accompanying drawings.

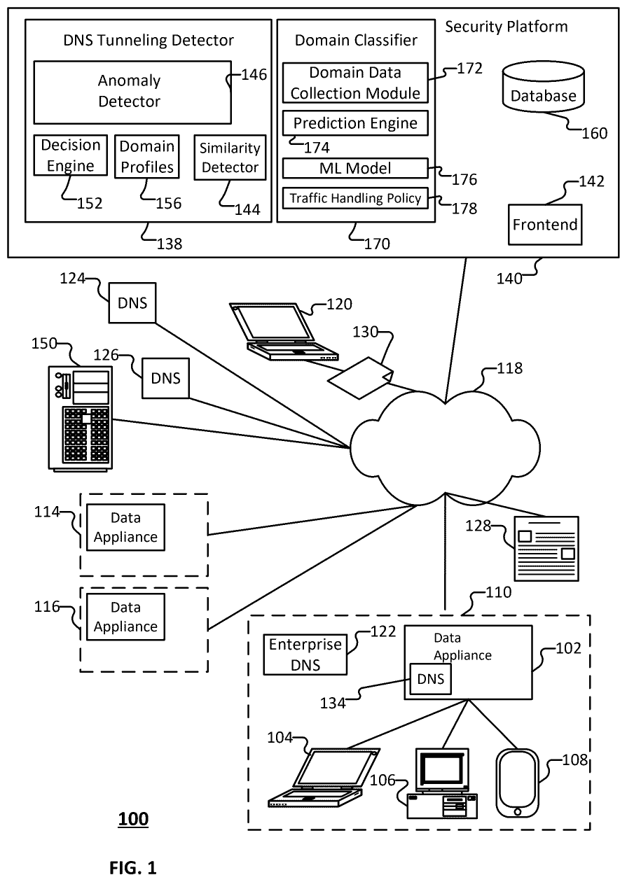

FIG. 1 is a block diagram of an environment for detecting higher-risk domains according to various embodiments.

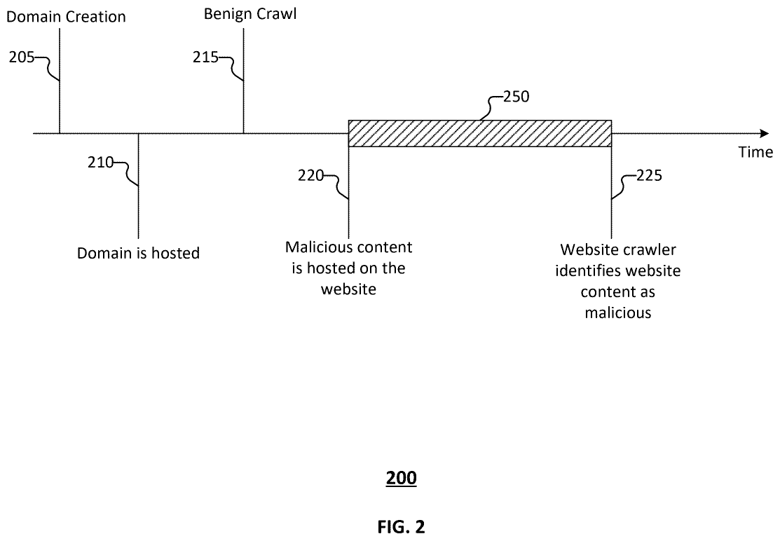

FIG. 2 is an illustration of an example timeline for identifying malicious websites.

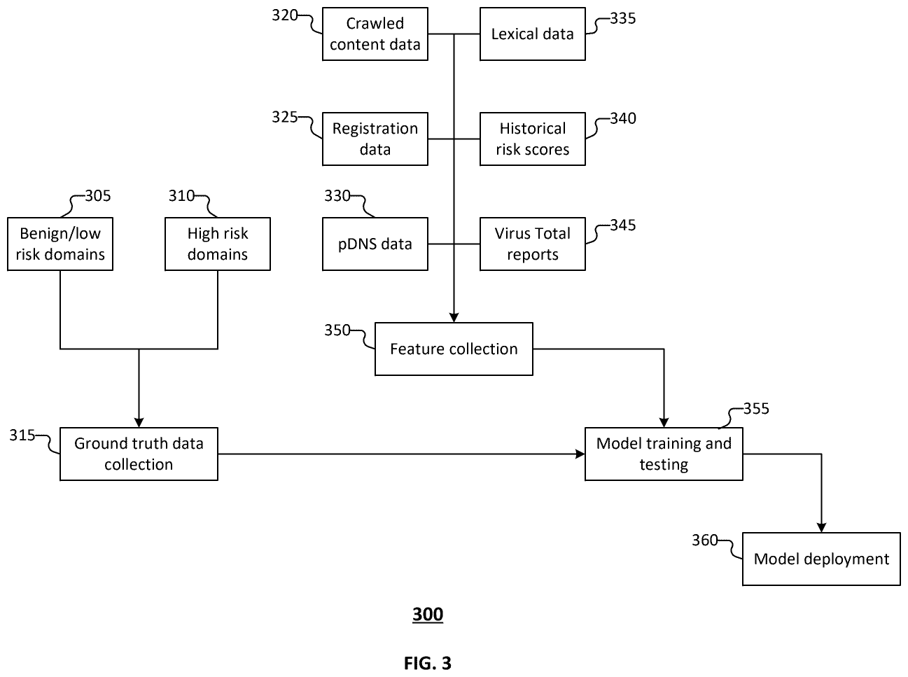

FIG. 3 is an illustration of a system for training a model to detect high-risk or malicious domains according to various embodiments.

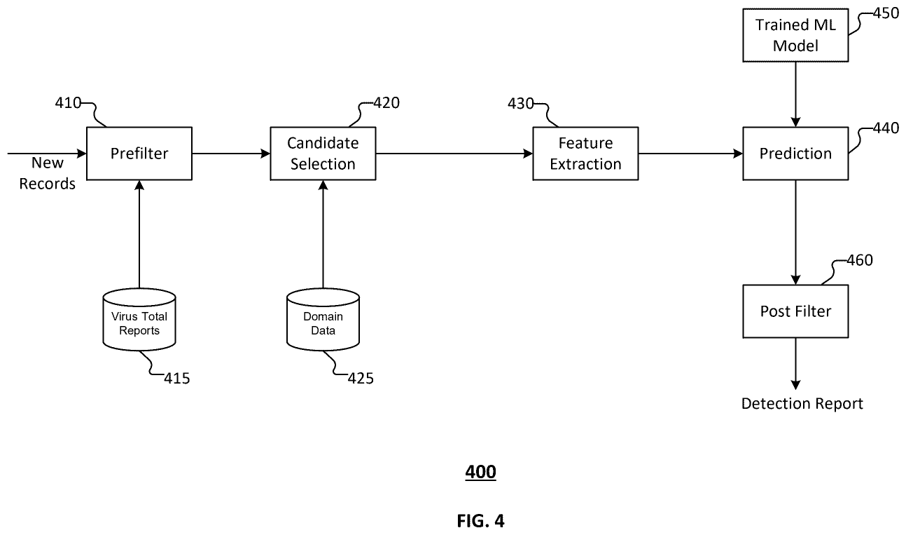

FIG. 4 is an illustration of a service for classifying domains according to various embodiments.

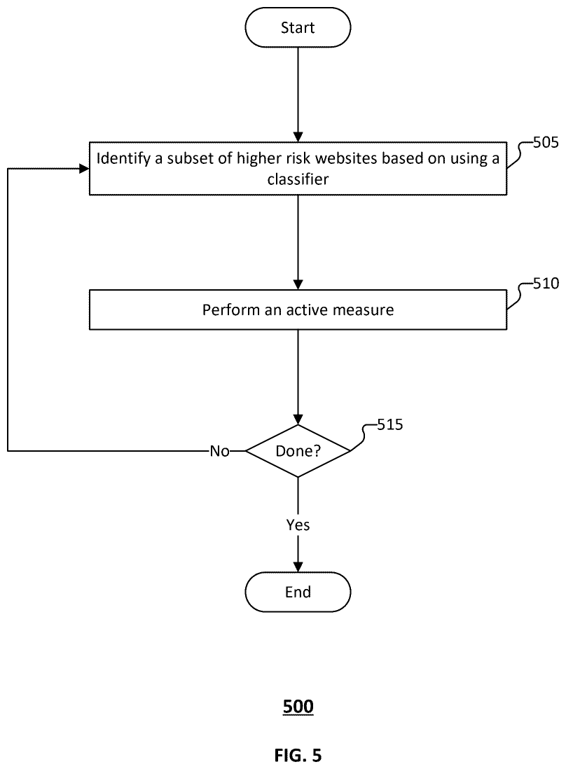

FIG. 5 is a flow diagram of a method for identifying higher-risk websites according to various embodiments.

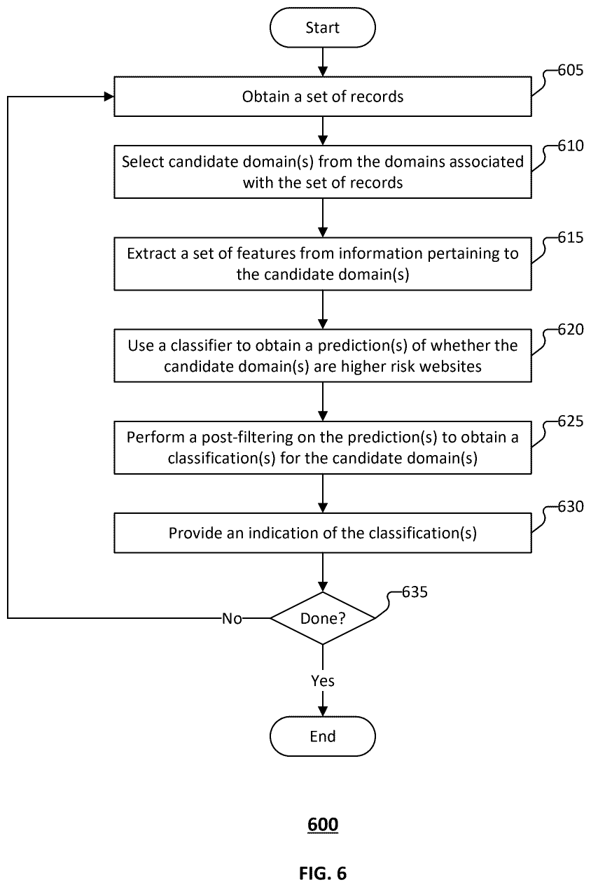

FIG. 6 is a flow diagram of a method for classifying a domain according to various embodiments.

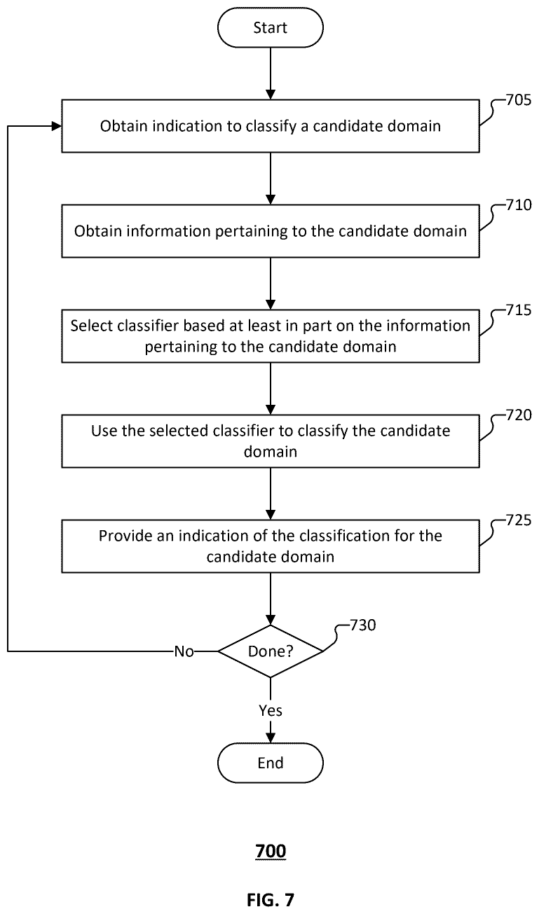

FIG. 7 is a flow diagram of selecting and using a classifier to classify a domain according to various embodiments.

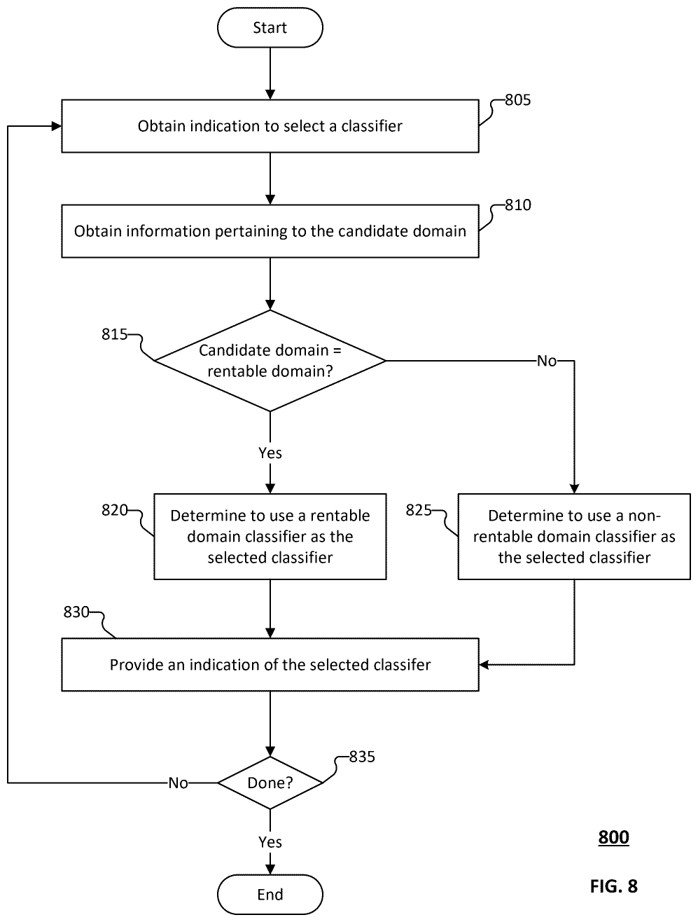

FIG. 8 is a flow diagram of a method for selecting a classifier to classify a domain according to various embodiments.

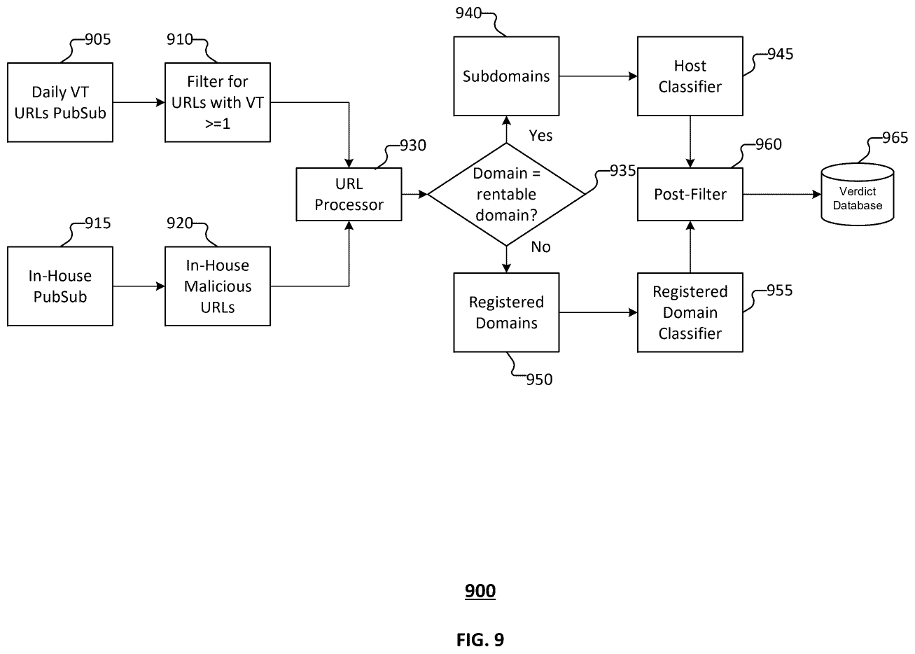

FIG. 9 is an illustration of an inference pipeline for determining risk scoring for a set of domains according to various embodiments.

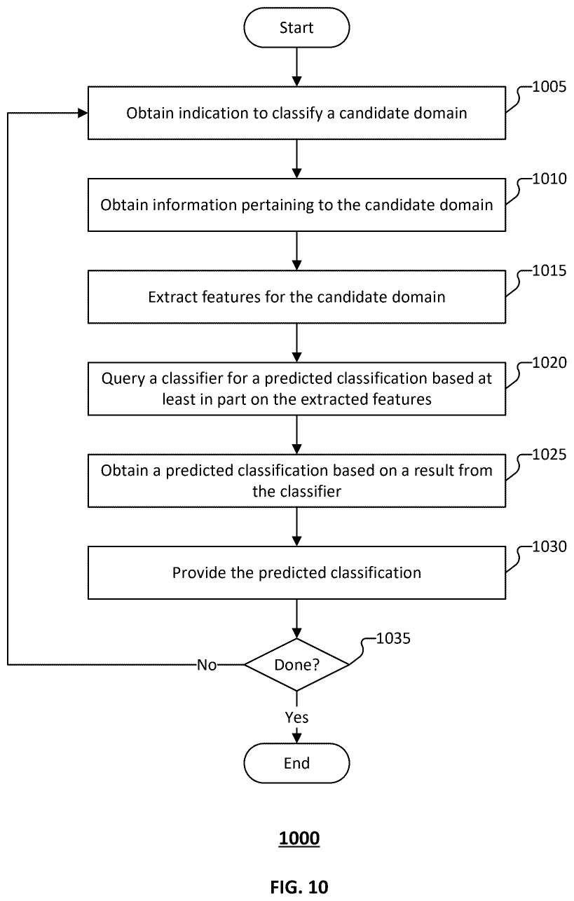

FIG. 10 is a flow diagram of a method for using a classifier to predict a domain classification according to various embodiments.

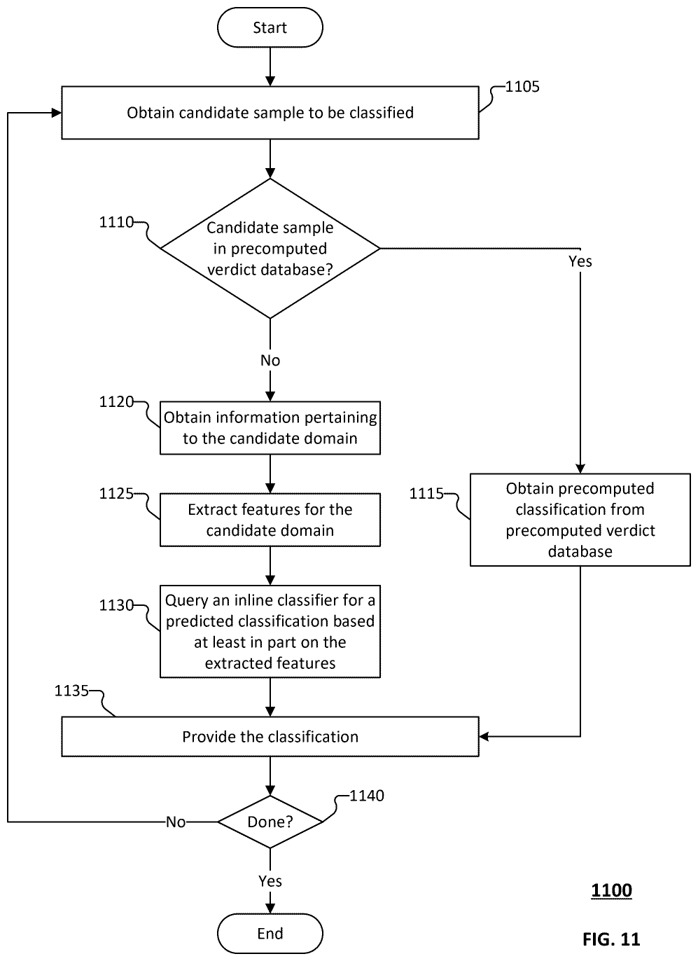

FIG. 11 is a flow diagram of a method for performing inline classification of a domain according to various embodiments.

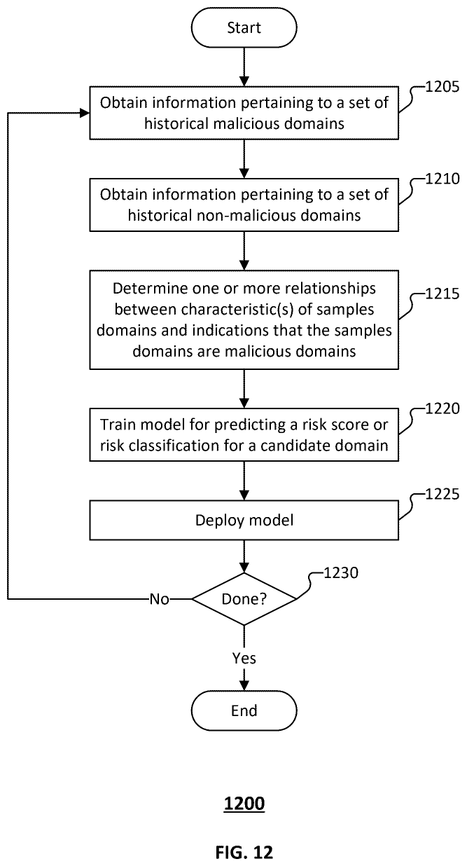

FIG. 12 is a flow diagram of a method for training a model according to various embodiments.

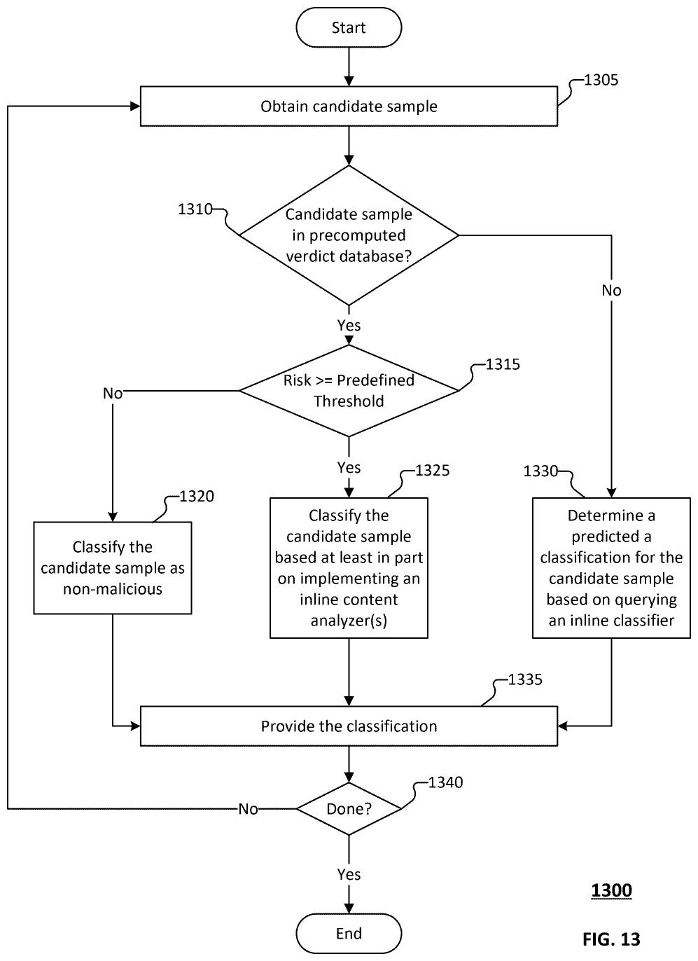

FIG. 13 is a flow diagram of a method for performing inline classification of a domain according to various embodiments.

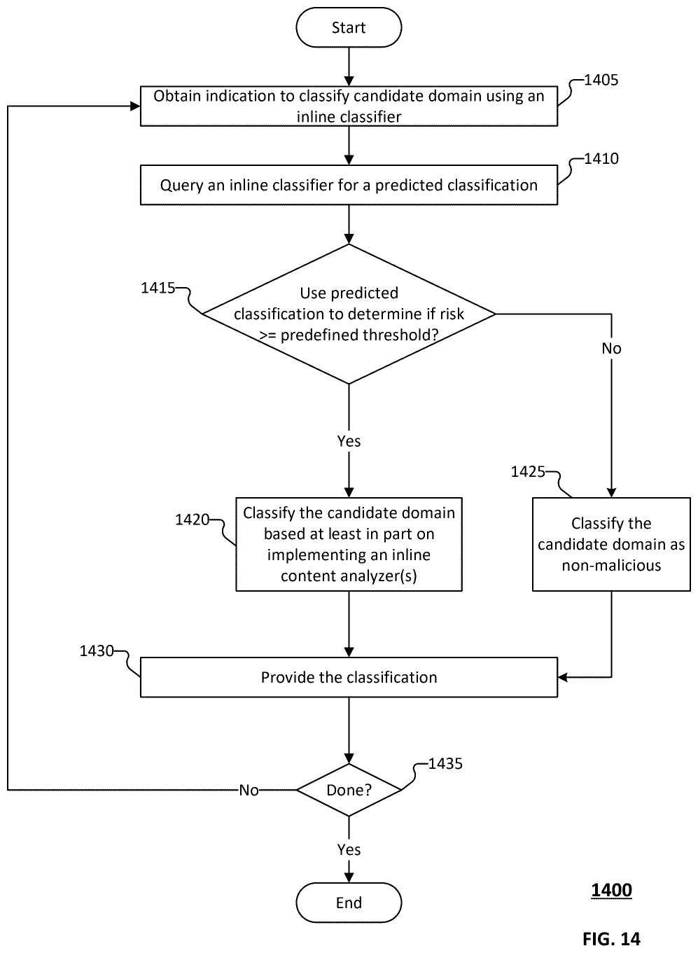

FIG. 14 is a flow diagram of a process for using an inline classifier to perform inline classification of a domain according to various embodiments.

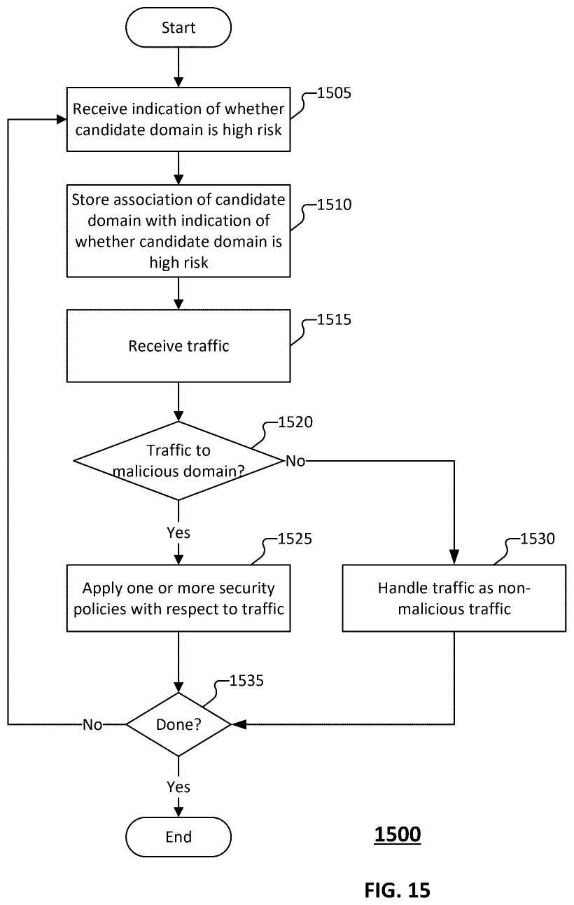

FIG. 15 is a flow diagram of a method for detecting malicious traffic according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

As used herein, the term “WHOIS record” refers to a record including registration information pertaining to a corresponding domain such as a root domain. Examples of information comprised in the registration information include a name of an owner, an owner contact information (e.g., mailing address) address, a date that the corresponding domain was registered, a company or organization associated with the owner, etc.

As used herein, a feature is a measurable property or characteristic manifested in input data, which may be raw data. As an example, a feature may be a set of one or more relationships manifested in the input data. Examples of types of features include: numerical features, categorical features, ordinal features, binary features, etc.

As used herein, a security entity is a network node (e.g., a device) that enforces one or more security policies with respect to information such as network traffic, files, etc. As an example, a security entity may be a firewall. As another example, a security entity may be implemented as a router, a switch, a DNS resolver, a computer, a tablet, a laptop, a smartphone, etc. Various other devices may be implemented as a security entity. As another example, a security may be implemented as an application running on a device, such as an anti-malware application.

As used herein, a rentable domain may comprise a domain for which the registrant permits other users to create subdomains. The rentable domain may correspond to a domain name that is leased or rented to individuals or businesses for a specified period. In the context of the internet, a domain name serves as the address where users can access a website. Instead of outright purchasing a domain name, some individuals or businesses may choose to rent or lease it from the domain owner. This arrangement allows the renter to use the domain name for their website or online presence without having to make a significant upfront investment in purchasing the domain outright. Rentable domains can be an attractive option for businesses looking for short-term or flexible arrangements, or for individuals who may not want to commit to the long-term ownership of a domain name. As another example, the registered domain owner permits other users to create pages sitting under the registered domain. The registered domain owner may allow other users to create subdomains in connection with performing a service, such as a file serving service (e.g., a drop box service), a web hosting company (e.g., Weebly™), a blog posting service, etc.

As used herein, a non-rentable domain may comprise a domain name that is not available for lease or rental by individuals or businesses. Instead, it is either owned outright by an individual or organization who intends to use it exclusively for their own purposes, or it may be reserved by a domain registrar or registry for various reasons such as technical or policy restrictions. Generally, non-rentable domains are actively used by their owners for websites, email services, or other online purposes. These owners typically have full control over the domain and can make decisions about its usage, content, and configuration. Non-rentable domains are usually purchased outright through domain registrars and are subject to renewal fees to maintain ownership.

Many malicious domains do not have any indicators of compromise (IOCs) at the time of initial discovery. Accordingly, related art systems (e.g., content-based detectors) are unable to classify the domains as malicious. However, many of the domains are weaponized with time. Empirical evidence indicates that on the order of 60% of malicious domains were initially crawled and identified as benign. One way to detect and block malicious URLs from such domains is to analyze all URLs inline before reaching users. However, it is impractical and a waste of resources to execute detectors inline on all URLs accessed by users as the overwhelming majority of Internet URLs are benign. Various embodiments are thus configured to provide an efficient manner for identifying likely malicious URLs and perform inline detection in order to improve (e.g., maximize) the coverage and reduce (e.g., minimize) the overhead.

According to various embodiments, the system prioritizes domains to be further evaluated/classified, such as by inline detectors (e.g., to avoid the system from having to evaluate every domain when intercepting traffic). The system can prioritize the domains according to riskiness, such as a predicted risk level for the domains.

A system, method, and computer system for determining a machine-learning powered domain risk score for a candidate domain is disclosed. The system, method, and computer system can be configured to provide real-time detection of malicious URLs based on a machine-learning powered domain risk scoring. The method includes (i) identifying a subset of higher risk websites, wherein the higher risk websites are at risk for potential malware injection or modification, and (ii) in response to identifying the subset of higher risk websites, performing an active measure based at least in part on the identified subset of higher risk websites.

A system, method, and computer system for training a classifier to determine a machine-learning powered domain risk score for a candidate domain. The classifier can be configured to perform real-time detection of malicious URLs based on a machine-learning powered domain risk scoring. The method includes (i) collecting a set of features for a set of training sample websites, the set of training sample websites comprising a subset of benign or low risk domains, and a subset of high risk domains, (ii) performing a machine learning process to generate a domain classifier based at least in part on the set of features for the set of training sample websites, and (iii) deploying the domain classifier in a system to perform detection of malicious domains. The set of features may be generated based at least in part one or more of crawled website content, lexical data, registration historical risk scores, passive DNS (pDNS) data, and Virus Total (VT) reports. The machine learning process may implement one or more machine learning models such as a random forest technique or an XGBoost.

In some embodiments, a device is trying to access a URL in real time. An inline security entity (e.g., a firewall) intercepts the traffic attempting to access the URL. The system (e.g., the inline security entity or a cloud service queried by the inline security entity) queries a risk database to determine if the domain for the URL is identified as a higher risk domain (e.g., a domain having a risk score greater than a predefined threshold). If the system determines that the domain is in the risk database and has a risk level or risk score greater than the predefined threshold, the system queries an inline content detector to classify the domain (e.g., to perform an inline or real-time classification). Alternatively, if the system determines that the domain is not in the risk database, the system can use an inline model/classifier to determine a risk score for the domain, and then in response to determining that the domain has a risk level or risk score greater than the predefined threshold, the system queries the inline content detector to classify the domain.

FIG. 1 is a block diagram of an environment for detecting higher-risk domains according to various embodiments. In various embodiments, system 100 is implemented in connection with system 300 of FIG. 3, system 400 of FIG. 4, and/or system 900 of FIG. 9, or one or more of processes 500-800 and 1000-1500 of FIGS. 5-8 and 10-15.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively block traffic, such as traffic to malicious domains, DNS hijacked domains, or stockpiled domains, or such as traffic for certain applications (e.g., SaaS applications). In some embodiments, data appliance 102 is also configured to enforce policies with respect to traffic that stays within (or from coming into) enterprise network 110.

Techniques described herein can be used in conjunction with a variety of platforms (e.g., desktops, mobile devices, gaming platforms, embedded systems, etc.) and/or a variety of types of applications or web applications (e.g., Android .apk files, iOS applications, Windows PE files, Adobe Acrobat PDF files, Microsoft Windows PE installers, etc.). In the example environment shown in FIG. 1, client devices 104-108 are a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including determining (e.g., predicting) a risk score or risk level for a domain, classifying domains (e.g., predicting whether a domain is a DNS hijacked domain, etc.), classifying network traffic, providing a mapping of signatures to certain domains (e.g., domains for which a predicted likelihood that the domain is a DNS hijacked domain exceeds a predefined likelihood threshold, etc.), performing static and dynamic analysis on malware samples, monitoring new domains (e.g., detecting new domains for which a certificate is issued/generated), assessing maliciousness of domains, determining whether a domain associated with a traffic sample is (or is likely to be) a DNS hijacked domain, providing a list of signatures of known exploits (e.g., malicious input strings, malicious files, malicious domains, etc.) to data appliances, such as data appliance 102 as part of a subscription, detecting exploits such as malicious input strings, malicious files, or malicious domains (e.g., an on-demand detection, or periodical-based updates to a mapping of domains to indications of whether the domains are malicious or benign), providing a likelihood that a domain is malicious (e.g., a parked domain, a DNS hijacked domain, etc.) or benign (e.g., an unparked domain), providing/updating a whitelist of input strings, files, or domains deemed to be benign, providing/updating input strings, files, or domains deemed to be malicious, identifying malicious input strings, detecting malicious input strings, detecting malicious files, predicting whether input strings, files, or domains are malicious, providing an indication that an input string, file, or domain is malicious (or benign), simulating DNS hijacking attacks/campaigns (e.g., generating synthetic DNS hijacking records), and training classifiers (e.g., training machine learning models, such as to be used to provide inline detection of DNS hijacked domains, or offline detection of DNS hijacked domains).

In some embodiments, security platform 140 classifies the domains in response to receiving a network traffic sample or according to a predefined schedule. For offline detection of domain risk levels or domain risk scores (which can be used to determine a corresponding risk level based on a mapping of risk score ranges to risk levels), security platform 140 can obtain information pertaining to the domains (e.g., pDNS data, geolocation data, etc.) and classify the domains based at least in part on querying a machine learning model. Security platform 140 may perform periodic polling or monitoring of URLs and/or corresponding domain data (e.g., pDNS data, lexical data, registration data, etc.), such as in connection with training a classifier, pre-computing a subset of features to be used for inline classifications (e.g., features to be provided to inline security entities, such as firewalls, to perform the inline classifications), and/or classifying a set of domains.

Security platform 140 may process the collected records and corresponding data pertaining to the domains (e.g., the pDNS data, the geolocation data, etc.) in batches such as according to a predefined frequency (e.g., daily, weekly, etc.). The periodic polling or monitoring may be performed according to a predefined schedule or a predefined frequency or time period (e.g., daily, weekly, monthly, etc.). Additionally, or alternatively, security platform 140 determines (e.g., predicts) a domain classification (e.g., a risk level classification, or a risk score classification) in response to receiving a domain request from an endpoint or network entity, such as a data appliance or other firewall or security entity. For example, security platform 140 can perform the domain classification on a domain request basis as the endpoint or network entity detects traffic for a new domain or suspicious traffic to/from a domain.

In various embodiments, results of analysis (and additional information pertaining to applications, domains, etc.), such as an analysis or classification performed by security platform 140, are stored in database 160. In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remaining portions of security platform 140 provided by dedicated hardware owned by and under the control of the operator of security platform 140.

In some embodiments, domain classifier 170 detects/classifies a domain. For example, domain classifier 170 predicts whether a risk level or risk score for a particular domain (e.g., a candidate domain). Domain classifier 170 can additionally classify the domain as malicious or benign. For example, domain classifier 170 can send a subset of the domains for which a risk level is determined to another domain classifier that analyzes the domain along different data vectors (e.g., web content detectors, etc.) to determine whether the domain is malicious or benign.

In some embodiments, domain classifier 170 classifies the domain based at least in part on a signature of the candidate domain, such as by querying a mapping of signatures to domain identifiers (e.g., a set of previously analyzed/classified applications). As an example, domain classifier 170 uses a signature or domain identifier to query a blacklist of domains to check whether the candidate domain is on the blacklist of domains. In some embodiments, domain classifier 170 classifies the domain based on a predicted domain classification. For example, domain classifier 170 determines (e.g., predicts) the domain classification based at least in part on domain data for a particular domain. Examples of domain data include a certificate information pertaining to a certificate(s) associated with the candidate domain (e.g., the domain associated with the particular domain request), registration information, pDNS data, geolocation data, scan data, active DNS information, zone file information, Whois registry data, web crawled data (e.g., data obtained by crawling the website), lexical data, third party assessments, analyses, or ratings (e.g., VirusTotal™ reports), historical domain data, etc.

In some embodiments, domain classifier 170 determines a domain classification for a candidate domain based at least in part on a machine learning-based classification. As an example, domain classifier 170 uses a machine learning-based classifier to determine a prediction of a risk score for the domain or a risk level for the domain. The machine learning-based classifier may predict whether the particular domain being evaluated is a high risk domain. Additionally, domain classifier 170 may use another model to classify the domain as malicious or benign. Additionally, domain classifier 170 may implement one or more of a fingerprinting-based classification, a heuristics-based classification, or other rule-based classification to classify the domain.

Domain classifier 170 performs a post-filtering with respect to the predictions generated by the machine learning-based classifier. The post-filtering can be performed using a fingerprinting-based classifier, a heuristics-based classifier, and/or other rule-based classifier to filter out potential false positives generated by the machine learning-based classifier (e.g., to remove candidate domains that are not likely to become malicious within a predefined period of time). The post-filtering may be performed to reduce the occurrences of false positive classifications.

In some embodiments, domain classifier 170 includes a model (e.g., ML model 176) that is trained to determine a risk level or risk score for a domain. Domain classifier 170 may implement different models based on a particular domain type or class. For example, domain classifier 170 can implement a first classifier (e.g., a host classifier) to determine a risk score or risk level for a rentable domain, and a second classifier (e.g., a registered domain classifier) to determine a risk score or risk level for a non-rentable domain.

In some embodiments, domain classifier 170 is additionally trained to detect malicious domains. In response to determining a predicted classification for a domain (e.g., a candidate domain), domain classifier 170 may determine a signature for the domain and store in a mapping of signatures to domains classifications (e.g., an indication of whether the candidate domain is malicious or benign/non-malicious) the domain signature in association with the predicted classification. In some embodiments, in response to determining a predicted classification for a domain (e.g., a candidate domain), domain classifier 170 may store an association between the IP address for network traffic and an indication of whether the IP address or associated domain is malicious or benign/non-malicious. For example, domain classifier 170 identifies an IP address to/from which is being communicated (e.g., an IP address for the client device corresponding to a beacon in a C2 framework) and detects whether the IP address or associated domain is malicious (e.g., performs a domain classification to classify the domain as DNS-hijacked or not DNS hijacked, or malicious/non-malicious).

In some embodiments, system 100 (e.g., domain classifier 170, security platform 140, etc.) trains a classifier (e.g., a model, such as ML model 176) to predict a risk level or risk fore for a domain and/or a classifier to detect (e.g., predict) maliciousness for domains. For example, system 100 trains a classifier to perform domain classification (e.g., to classify domains as malicious or benign/non-malicious). The classifier(s) is trained based at least in part on a machine learning process. System 100 may train different models for different types of domains (e.g., rentable versus non-rentable) or for different pipelines (e.g., to perform inline classifications or offline classification). Examples of machine learning processes that can be implemented in connection with training the classifier(s) include random forest, linear regression, support vector machine, naive Bayes, logistic regression, K-nearest neighbors (KNN), decision trees, gradient boosted decision trees, a neural network (NN), etc. In some embodiments, domain classifier 170 implements a random forest model.

In some embodiments, system 100 trains a first classifier to perform offline classifications (e.g., to generate classifications via an offline detection pipeline) and/or a second classifier to perform inline classifications (e.g., to generate classifications via an inline detection pipeline, such as contemporaneous with the interception and handling of traffic or enforcement of security policies). The first classifier may be trained using more features than the second classifier. Accordingly, the first classifier may be more accurate/robust but is associated with a higher latency detection pipeline (e.g., more features have to be computed or data retrieved from data sources/services).

System 100 (e.g., domain classifier 170, security platform 140, etc.) performs feature extraction with respect to the candidate domain from domain data (e.g., pDNS data, geolocation data, certificates, registrant information, lexical data, historical data, scan data, etc.). In some embodiments, system 100 (e.g., domain classifier 170) generates a set of features for training a machine learning model for predicting a risk score or risk level for the domain, or for classifying the domain (e.g., classifying whether the domain is malicious/non-malicious). System 100 then uses the set of features to train a machine learning model (e.g., a random forest model) such as based on training data that includes benign samples of domains and malicious samples of domains.

According to various embodiments, security platform 140 comprises DNS tunneling detector 138 and/or domain classifier 170. Security platform 140 may include various other services/modules, such as a malicious file detector, a malicious traffic detector, a parked domain detector, a DNS hijacked domain detector, a risk level classifier, a risk score predictor, an application classifier or other traffic classifier, etc. Domain classifier 170 is used in connection with analyzing samples of domains and/or automatically detecting high risk domains or malicious domains. For example, domain classifier 170 analyzes a candidate domain and predicts a risk level or predicts whether the domain is malicious. In response to receiving an indication that an assessment of a candidate domain (e.g., a domain classification, a risk level classification, a determine whether the candidate domain is malicious/benign, etc.) is to be performed, domain classifier 170 analyzes the candidate domain and obtains domain data for the candidate domain to determine the assessment of the candidate domain.

In some embodiments, in connection with determining the machine learning-based prediction classification, domain classifier 170 (i) receives an indication of a candidate domain or otherwise performs a candidate domain selection, (ii) obtains information pertaining the candidate domain (e.g., domain data such as pDNS data, registration data, historical data, lexical data, etc.), (iii) determines a feature vector for the candidate domain based on the information pertaining to the candidate domain, (iv) queries a model (e.g., a machine learning model), and (v) determines a domain classification, or otherwise determines a risk level or risk score for the domain based on the querying the model (e.g., domain classifier 170 obtains a predicted classification).

In some embodiments, domain classifier 170 comprises one or more of domain collection module 172, prediction engine 174 (e.g., a DNS-hijacked domain detector), ML model 176, and/or traffic handling policy 178.

Domain collection module 172 is used in connection with obtaining samples (e.g., records or domains) such as based on network traffic or a predefined list. Domain collection module 172 obtains information pertaining to a domain, such as in connection with identifying certain elements of domain data for the domain. Domain data collection module 172 may query a dataset or third-party service(s) for domain data. For example, domain data collection module 172 may query a WHOIS database for registrant information, passive DNS (pDNS) datasets or logs, active DNS datasets or logs, geolocation datasets or services, third party domain assessment or rating services (e.g., VirusTotal™ reports, etc.), certificate logs (e.g., to obtain certificates for the particular domain), etc. Domain collection module 172 extracts information from the domain data or the domain name itself.

Prediction engine 174 is used in connection with predicting a classification for the domain (e.g., the candidate domain), such as to classify the risk level for the domain, predict a risk score for the domain, or to classify the domain as malicious or benign/non-malicious.

In some embodiments, prediction engine 174 performs a machine learning-based classification, for example, by querying ML model 176. Domain classifier 170 (e.g., prediction engine 174) may be further configured to post-filter the predictions generated by the machine learning model (e.g., the machine learning-based classifications), such as to reduce the number of false positives. The post-filtering can implement a fingerprinting-based classification/filtering, a heuristic-based classification/filtering, or another rule-based classification filtering.

In some embodiments, the classifier (e.g., ML model 176) is trained using a machine learning process. For example, the classifier is a random forest model. As an example, the ML model is trained from a training set comprising a subset of benign records or domains (e.g., records for known or previously classified benign domains) and a subset of malicious records or domains. As another example, the ML model is trained from a training set of domains comprising a subset of high risk domains, a subset comprising medium risk domains, and a subset comprising low risk domains. As another example, the ML model is trained from a training set of domains comprising a subset of domains that became malicious within a predefined period of time after evaluation/classification and a subset of domains that remain benign within a predefined period of time after evaluation/classification.

According to various embodiments, in response to prediction engine 174 determining a risk level or risk score for the candidate domain, system 100 determines whether to further evaluate (e.g., classify) the domain to determine the manner for handling the traffic to/from the candidate domain according to a predefined policy (e.g., a security policy). The system may store a predefined policy indicating thresholds for classifying domains into different risk levels or to identify ranges of risk scores or subset of risk levels for which corresponding domains are to be further evaluated/classified.

According to various embodiments, in response to prediction engine 174 classifying the candidate domain, system 100 handles the traffic to/from the candidate domain according to a predefined policy (e.g., a security policy). For example, the system queries traffic handling policy 178 to determine the manner by which traffic to/from a domain matching the candidate domain is to be handled. Traffic handling policy 178 may be a predefined policy, such as a security policy, etc. Traffic handling policy 178 may indicate that traffic to/from certain domains is to be blocked and traffic to/from other domains is to be permitted to pass through the system (e.g., routed normally). Traffic handling policy 178 may correspond to a repository of a set of policies to be enforced with respect to network traffic. In some embodiments, security platform 140 receives one or more policies, such as from an administrator or third-party service, and provides the one or more policies to various network nodes, such as endpoints, security entities (e.g., inline firewalls), etc.

In response to determining a classification for a newly analyzed candidate domain, security platform 140 (e.g., domain classifier 170) sends an indication that domains matching the candidate domain are associated with, or otherwise correspond to, the determined classification. In the case that the determined classification for the candidate domain is that is a higher risk domain (e.g., a high risk domain, or a high risk or medium risk domain), security platform 140 provides an indication that traffic to/from a domain matching the candidate domain (e.g., the same domain signature or same originating IP address, etc.) is to be further classified a malicious/non-malicious such as in line with the handling of traffic. For example, security platform 140 determines (e.g., computes) a signature or identifier for the candidate domain (e.g., a hash or other signature), and sends to a network node (e.g., a security entity, an endpoint such as a client device, etc.) an indication of the classification associated with the signature (e.g., an indication of whether the domain is a higher risk domain, or an indication of whether the domain is a malicious/non-malicious domain). Security platform 140 may update a mapping of signatures to domain classifications and provide the updated mapping to the security entity. In some embodiments, security platform 140 further provides to the network node (e.g., security entity, client device, etc.) an indication of a manner by which traffic to a domain matching the signature is to be handled. For example, security platform 140 provides to the security entity a traffic handling policy, a security policy, or an update to a policy.

In some embodiments, system 100 (e.g., prediction engine 174 of network traffic classifier, an inline firewall or other inline security entity, etc.) determines whether information pertaining to a particular candidate domain (e.g., a newly received candidate domain to be analyzed) is comprised in a dataset of historical domains (e.g., historical network traffic, previously classified domains), whether a particular signature is associated with malicious traffic, or whether traffic corresponding to the candidate domain to be otherwise handled in a manner different than the normal traffic handling. The historical information may be provided by another system or module, such as a service running on security platform 140, or by a third-party service such as VirusTotal™, or both. In response to determining that information pertaining to a candidate domain is not comprised in, or available in, the dataset of historical domains (e.g., historical or previously analyzed domains), system 100 (e.g., domain classifier 170 or other inline security entity) may deem that the domain/traffic has not yet been analyzed and system 100 can invoke an analysis (e.g., a domain analysis) of the candidate domain (e.g., an analysis of the domain data for the candidate domain) in connection with determining (e.g., predicting) the domain classification (e.g., an inline security entity can query a classifier, such as domain classifier 170 that uses the header information for the domain or network traffic to query a machine learning model). The historical information (e.g., from a third-party service, a community-based score, etc.) indicates whether other vendors or cyber security organizations deem the particular traffic as malicious or should be handled in a certain manner.

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

As an illustrative example, the environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable.

As mentioned above, in order to connect to a legitimate domain (e.g., www.example.com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite.com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious domains, detecting parked domains, or otherwise determining that certain detected network traffic is to be further analyzed (e.g., using a finer detection model).

In various embodiments, when a client device (e.g., client device 104) attempts to resolve an SQL statement or SQL command, or other command injection string, data appliance 102 uses the corresponding domain (e.g., an input string) as a query to security platform 140. This query can be performed concurrently with the resolution of the SQL statement, SQL command, or other command injection string. As one example, data appliance 102 can send a query (e.g., in the JSON format) to a frontend 142 of security platform 140 via a REST API. Using processing described in more detail below, security platform 140 will determine whether the queried SQL statement, SQL command, or other command injection string indicates an exploit attempt and provide a result back to data appliance 102 (e.g., “malicious exploit” or “benign traffic”).

In various embodiments, when a client device (e.g., client device 104) attempts to open a file or input string that was received, such as via an attachment to an email, instant message, or otherwise exchanged via a network, or when a client device receives such a file or input string, DNS module 134 uses the file or input string (or a computed hash or signature, or other unique identifier, etc.) as a query to security platform 140. In other implementations, an inline security entity queries a mapping of hashes/signatures to traffic classifications (e.g., indications that the traffic is C2 traffic, indications that the traffic is malicious traffic, indications that the traffic is benign/non-malicious, etc.). This query can be performed contemporaneously with receipt of the file or input string, or in response to a request from a user to scan the file. As one example, data appliance 102 can send a query (e.g., in the JSON format) to a frontend 142 of security platform 140 via a REST API. Using processing described in more detail below, security platform 140 will determine (e.g., using a malicious file detector that may use a machine learning model to detect/predict whether the file is malicious) whether the queried file is a malicious file (or likely to be a malicious file) and provide a result back to data appliance 102 (e.g., “malicious file” or “benign file”).

In some embodiments, security platform 140 comprises a network traffic classifier that provides to a security entity, such as data appliance 102, an indication of the traffic classification. For example, in response to detecting the C2 traffic, network traffic classifier sends an indication that the domain traffic corresponds to C2 traffic to data appliance 102, and the data appliance 102 may in turn enforce one or more policies (e.g., security policies) based at least in part on the indication. The one or more security policies may include isolating/quarantining the content (e.g., webpage content) for the domain, blocking access to the domain (e.g., blocking traffic for the domain), isolating/deleting the domain access request for the domain, ensuring that the domain is not resolved, alerting or prompting the user of the client device the maliciousness of the domain prior to the user viewing the webpage, blocking traffic to or from a particular node (e.g., a compromised device, such as a device that serves as a beacon in C2 communications), etc. As another example, in response to determining the application for the domain, the network traffic classifier provides to the security entity with an update of a mapping of signatures to applications (e.g., application identifiers).

FIG. 2 is an illustration of an example timeline for identifying malicious websites. In the example shown, a timeline 200 of the lifecycle for detecting a website hosting malicious content at a particular domain is provided. At 205, the domain created. At 210, the domain is hosted. At 215, the hosted domain is crawled, and the results of the crawling is a determination that the content hosted at the domain is benign. For example, the crawling is performed by a security service such as security platform 140. The security service can crawl a set of domains according to a predefined frequency. In connection with crawling the website, the security service/system can classify the domain as malicious or benign/non-malicious. For example, the security service crawls the content hosted at the domain, and queries/uses a classifier to predict a classification of the domain based at least in part on the content. At 220, malicious content is hosted on the website. At 225, the hosted domain is crawled, and website content hosted at the domain is deemed malicious. For example, the security service crawls the particular according to a predefined frequency or in response to a certain event occurring. The crawl at 225 may be the first crawl since the time at 220 when the website is configured to host malicious content.

During the time (e.g., the window of exposure) between when malicious content is hosted on the website at 220 and when the website content is first classified/deemed to be malicious at 225, devices communicating with the domain are vulnerable to a malicious attack. Various embodiments strive to shorten the window of exposure to malicious websites. In some embodiments, the system performs a real-time detection to identify a risk associated with a domain and to classify the domain. Accordingly, a malicious domain may be properly classified before the next scheduled/periodic web crawl.

Various embodiments implement a machine learning (ML) based risk scoring for domains. The system uses the risk scoring to rank domains that are not currently malicious but are deemed likely to be malicious in the near future. The system can be configured to monitor domains having a risk score exceeding a predefined threshold (e.g., a predefined risk score threshold) in real-time (or contemporaneous with the interception/mediation of traffic to/from the domain). For example, the system can use the domain risk scores to identify traffic to/from a high risk domain, and cause a real-time/contemporaneous maliciousness classification to be performed to classify the domain. In response to classifying the domain as malicious, the system can handle the traffic appropriately, such as in accordance with a predefined security policy.

Because the volume of URLs associated with high risk domains is much lower than all the volume of all URLs accessed by users, the system can efficiently perform inline detection on URLs for these high risk domains. Additionally, the system may perform inline detection with respect to domains deemed to be medium risk (e.g., based on the predicted risk score) such as to make the maliciousness detection to be more sensitive at the expense of additional computational expense. A high risk domain may correspond to a domain having an associated risk score greater than (or greater than or equal to) a predefined risk score threshold such as a predefined high risk score threshold. A domain risk score may be between 0 and 1, inclusive, and as an illustrative example, a domain having a risk score exceeding a risk score threshold of 0.7 may be deemed a high risk domain.

According to various embodiments, the system is configured to classify domains that are likely to become malicious in the near future. The domains may be so classified by assigning a risk score between 0 and 1, inclusive, with a risk score closer to 1 being more likely to be malicious (e.g., more likely to be malicious in the near future or within a predefined period of time). The system implements a classifier to classify to the domains (e.g., to generate a predicted risk score).

In some embodiments, the classifier performs an ML-based computation of the risk score. For example, the classifier may comprise a ML model that uses an ML-based that generates a predicted risk score. The ML model can use information from a set of data sources. Examples of the data from the set of data sources include historical data/classifications, crawled content data, lexical data, registration data, historical risk scores, pDNS data, and third party risk assessments (e.g., VirusTotal™ reports, community ratings, etc.). Various other types of data or data sources can be implemented. The classifier extracts features based at least in part on this information from the set of data sources and queries the ML model for a predicted risk score.

The system can implement a multi-model approach for classifying different classes of domains, which naturally require different risk signals. As an example of two classes of domains include rentable domains and non-rentable domains. The system can use different models for rentable domains versus non-rentable domains. Additionally, or alternatively, the system can use different models for inline versus offline classifications. The inline classifiers/models can provide real-time classifications (e.g., to classify the domain contemporaneous with the interception and/or handling of traffic to/from the domain). In contrast, the offline models may be more robust and trained on more models to provide a more accurate classification offline (e.g., not contemporaneous with the interception and/or handling of traffic to/from the domain). In some embodiments, the system implements one or more of (i) an inline rentable domain classifier, (ii) an offline rentable domain classifier, (iii) an inline non-rentable domain classifier, and (iv) an offline non-rentable domain classifier. Additionally, the system can implement a certain set of the classifiers to predict risk scores (e.g., to predict a likelihood that the domain will be malicious in the near future or within a predefined period of time), and another set of classifiers to classify the maliciousness of the domain (e.g., to classify the maliciousness based at least in part on the content hosted at the domain, etc.).

According to various embodiments, the system determines that domains that are not malicious at the moment (e.g., no identifiable IOCs) but are likely to involve in malicious activity in the future (e.g., within a predefined time period) based on one or more the following: (a) some children URLs of these domains are known be malicious, (b) the domain is hosted on a bulletproof hosting service, (c) the domain is hosted on IP/ASNS with a low reputation (e.g., an IP/ASNS known to host many malicious domains), (d) the domain is an unknown, (e) DDNS domains, and (f) domains with generally a low reputation (e.g., based on third party reputation assessments or community ratings, etc.). In connection with detecting domains that are likely to become malicious in the future (or otherwise classifying the likelihood that a domain will become malicious within a predefined period of time), the system collects information pertaining to the one or more factors listed above, extracts from the collected information a set of features pertaining to the one or more factors, and queries a classifier based at least in part on the set of features.

FIG. 3 is an illustration of a system for training a model to detect high-risk or malicious domains according to various embodiments. In the example shown, system 300 is used for training risk-scoring machine learning models (e.g., models that predict a risk score for a domain).

As illustrated, system 300 comprises ground truth module 315 that is configured to collect ground truth data. Ground truth module 315 collects a set of benign or low risk domains and a set of high risk domains. Ground truth module 315 may additionally collect medium risk domains. In some embodiments, ground truth takes random stratified samples respectively from the set of benign or low risk domains and the set of high risk domains to ensure a representative ground truth and to avoid the trained model from being biased/skewed.

Ground truth module 315 can obtain an indication of domains that are known to be benign or low risk from one or more benign/low risk domain data sources 305. For example, ground truth module 315 can obtain the indication of the domains that are known to be benign or low risk from a third party ranking service (e.g., a list of the top ranked 100,000 domains or other predefined number of domains as rated by Tranco). As another example, ground truth module 315 can obtain an indication of benign/low risk benign from a whitelist of domains, such as a whitelist maintained by system 300 or other security service. As another example, ground truth module 315 obtain an indication of benign/low risk benign based on benign threat intelligence from domain experts or third party services, such as VirusTotal™ (VT) reports.

Ground truth module 315 can obtain an indication of domains that are known to be high risk (or malicious) from one or more high risk domain data sources 310. As an example, ground truth module 315 can obtain an indication of high risk domains based on known malicious domains from intelligence from domain experts or third party services. A list of high risk domains (or known malicious domains) can be obtained from a security service, such as a service that classifies traffic traversing an enterprise network. As another example, ground truth module can obtain an indication of high risk domains based third party analyses of domains, such as VT reports. For example, the system can obtain a VT report and deem a domain to be high risk or malicious if the domain has three VT hits (or some other predefined number of hits) on the corresponding VT report for the domain. As another example, the system can select those domains having known malicious children URLs.

System 300 also comprises feature extraction module 350 that is configured to extract a set of features for the domains. Examples of features that may be comprised in the set of features are further described in Tables 1-6 below. The set of features can be determined based at least in part on information pertaining to the domains from one or more data sources. Examples of the information pertaining to the domains include historical data/classifications, crawled content data, lexical data, registration data, historical risk scores, pDNS data, and third party risk assessments (e.g., VirusTotal™ reports, community ratings, etc.). Various other types of data can be obtained.

In some embodiments, the set of features comprises one or more of (i) one or more features pertaining to pDNS data, (ii) one or more features pertaining to crawled content, (iii) one or more features pertaining to lexical data, (iv) one or more features pertaining to registration data, and (vi) one or more features pertaining to historical risk scores.

Feature extraction module 350 obtains crawled content data from web crawler system/service 320. Feature extraction module 350 obtains registration data from registration system/service 325. Registration system/service 325 may be a system or service that queries a third party domain registration dataset, such as a dataset comprising Whois data). Feature extraction module 350 obtains pDNS data from pDNS system/service 330. pDNS system/service 330 may be a system/service that queries a pDNS dataset to obtain the pDNS data. Feature extraction module 350 obtains lexical data from lexical data system/service 335. Lexical data system/service 335 may be a system/service that performs lexical analysis on, and extracts lexical data from, URLs or website content hosted at a particular domain. Feature extraction module 350 obtains lexical data from historical risk scores system/service 340. Historical risk scores system/service 340 may be a system or service that queries a dataset of previously computed risk scores for domains. Feature extraction module 350 obtains third party risk assessments, such as VT reports, from third party assessment system/service 345. Third party assessment system/service 345 can obtain third party risk assessments by querying third party services or subscribing to feeds from third party services.

In response to extracting the set of features, system 300 trains a classifier, such as a machine learning model (e.g., a random forest model). The classifier is trained to classify domains that are predicted to be likely to become malicious in the near future or within a predefined time period. The classifier predicts the likelihood that the domain will become malicious in the near future or within the predefined time period by generating a risk score. The risk score may be a value between 0 and 1. A higher the score (e.g., a risk score closer 1) is indicative that a domain is deemed riskier (e.g., relatively higher risk). Examples of machine learning processes/techniques that can be implemented in connection with training the model include random forest, linear regression, support vector machine, naive Bayes, logistic regression, K-nearest neighbors, decision trees, gradient boosted decision trees, etc.

System 300 uses model training module 355 to train and test the model. In response to the model being trained, system 300 uses model deployment module 360 to deploy the model, such as by storing the model in a dataset and/or distributing the model to security entities, such as inline security entities for generating inline classifications.

In some embodiments, the system extracts one or more of the features comprised in Tables 1-6. The system may extract and implement additional features that are not comprised in Tables 1-6. In some embodiments, the system implements different sets of features for models trained to perform inline classifications (e.g., inline models) versus models trained to perform offline classifications (e.g., offline models). For example, offline models can be trained on and implement features that use historical data or data obtained via web crawling a website. As another example, inline models can be trained on and implement features that use snapshot data such as data from a current record, and such inline models do not use historical data or web crawled data to perform classifications. Additionally, or alternatively, the system implements different set of features for models trained to perform classifications for rentable domains versus models trained to perform classifications for non-rentable domains. Rentable domains and non-rentable domains can have very different characteristics and thus using different models to classify these different classes of domains is expected to result in a higher detection accuracy. As an example, the following types of classifiers (e.g., ML models) can implement different sets of features: (a) an inline rentable domain classifier, (b) an offline rentable domain classifier, (c) an inline non-rentable domain classifier, and (d) an offline nonrentable domain classifier.

Table 1 provides an example of features that can be obtained based at least in part on pDNS data pertaining to a domain. The pDNS data may be obtained from a pDNS dataset.

TABLE 1
Examples of Passive DNS Features

| Name | Description |
|---|---|
| Number of recent hosting | Number of IPs on which the domain is hosted |
| IPs | in the last 60 days |
| Number of recent hosting | Number of ASNs on which the domain is |
| ASNs | hosted in the last 60 days |
| Number of recent | Number of subnet/24 s on which the domain |
| subnet/24 | is hosted in the last 60 days |
| Query count | Number of times the domain is accessed in |
| | the last 60 days |
| Duration | Duration between first seen time and last seen |
| | time |
| Active Duration | Aggregation of all active durations |
| Days since last active | Number of days since the last seen time |
| Max inactive gap | Maximum inactive gap |
| Number of recent name | Number of name servers resolving the domain |
| servers | in the last 60 days |

Table 2 provides an example of features that can be obtained based at least in part on web crawled content data pertaining to a domain.

TABLE 2
Examples of Crawled Content Features

| Name | Description |
|---|---|
| Is parked | An indication of whether the domain |
| | currently is parked |
| Is insufficient content | An indication of whether the domain has |
| | insufficient content (e.g., less than a |
| | predefined threshold of content, or missing |
| | certain types of content) |
| Number of loading | Number of DNS interactions to load the page |
| communications | |
| HTTP status | HTTP status code |
| Content size | Size of the web page |
| Are security headers | An indication of whether security headers are |
| present | present in the response header |
| Malicious crawl | Percentages of crawled URLs for the domain |
| percentage | that are malicious |
| Length of the redirection | Length of the redirection chain |
| chain | |
| Does it redirect to a | An indication of whether the domain redirects |
| popular domain? | to a known popular domain included in |
| | Tranco 10K |

Table 3 provides an example of features that can be obtained based at least in part on lexical data pertaining to a domain.

TABLE 3
Examples of Lexical Features

| Name | Description |
|---|---|
| TLD reputation | The TLD (top level domain) reputation score |
| | calculated based previously observed |
| | malicious domains |
| Number of suspicious | Number of suspicious keywords such as |
| keywords | secure, verify and auth |
| Number of brand names | Number of brand names in Tranco 10K |
| | appearing in the domain name |
| Number of “minuses” | Number of “−” in the domain name |
| Is IDN? | An indication of whether the domain is an |
| | internationalized domain name |
| Number of embedded TLDs | Number of embedded TLDs |
| Entropy | The Shannon entropy of the domain name |

Table 4 provides an example of features that can be obtained based at least in part on registration data pertaining to a domain.

TABLE 4
Examples of Registration Features

| Name | Description |
|---|---|
| Registrar reputation score | Based on the inhouse maintained registrar |
| | reputation score calculated from known |
| | benign and malicious domains |
| Number of times the | Number of times the domain is renewed its |
| domain is renewed | registration |
| Duration | Time from the registration date |
| Days since last updated | Number of days since the domain was last |
| | updated |
| Number of name servers | Number of name servers mentioned in the |
| | registration record |
| Is the domain re-registered | An indication of whether the domain re- |
| | registered |
| Is the domain privacy | An indication of whether the domain privacy |
| protected | protected |
| Number of registration | Number of registration records created for |
| records | this domain |

Table 5 provides an example of features that can be obtained based at least in part on registration data pertaining to a domain.

TABLE 5
Examples of VirtusTotal Report Features

| Name | Description |
|---|---|
| Duration | Duration of the time from the first scan to the |
| | last scan |
| Number of malicious | Number of malicious URLs under this |
| URL scans | domain |
| Number of benign URL | Number of benign URLs under this domain |
| scans | |

Table 6 provides an example of features that can be obtained based at least in part on registration data pertaining to a domain.

TABLE 6
Examples of Historical Risk Score-based Features

| Name | Description |
|---|---|
| Number of low risk scores | Number of time in the past 60 days the |
| | domain is marked as low risk |
| The ratio of high to low risk | The ratio of high to low risk scores for the |
| scores | domain in the past 60 days |

FIG. 4 is an illustration of a service for classifying domains according to various embodiments. In some embodiments, system 400 is implemented at least in part by system 100 of FIG. 1. In some embodiments, system 400 implements at least part of one or more of processes 500-1500 of FIG. 5-15. In some embodiments, system 400 is implemented to implement a classifier (e.g., a machine learning model) to perform an ML-based domain classification, such as to classify whether the candidate domain is a likely to become malicious within a predefined period of time (e.g., in the near future).

In the example shown, system 400 provides a classification pipeline. As illustrated, the classification pipeline implements primarily six steps, including a pre-filtering, candidate selection, feature extraction, prediction generation, a post-filtering, and a classification (e.g., the determining of the final verdict based on the prediction and the post-filtering step). In some implementations, such as for inline classification pipelines, certain steps may be excluded, for example, the post-filtering step or certain aspects of the feature extraction.

As illustrated, new records are input to the classification pipeline. The new records may correspond to samples obtained by intercepting network traffic, or a periodic analysis of domains. A pre-filtering module 410 obtains the new records, such as in connection with system 400 receiving a request to perform a classification(s). Pre-filtering module 410 removes records that are not going to be used to generate classifications. For example, pre-filtering module 410 removes domains having a VirusTotal score of less than a predefined threshold (e.g., a VirusTotal score of less than 1) and domains known to be benign, etc. In other embodiments, another third party assessment (e.g., score) can be used in addition to, or alternative to, the VirusTotal score. Pre-filtering module 410 can query malicious URL data 415 to obtain a maliciousness score for the domain. Malicious URL data 415 may comprise data obtained from a malicious URL feed or third party assessment service. As an example, the malicious URL feed or third party assessment may be a VirusTotal service and the malicious URL data 415 may comprise a VirusTotal score for the domain. In some embodiments, various other third party services or domain rating services can be implemented. Various other types of records/domains can be pre-filtered. For example, the rules for pre-filtering records may be configured by an administrator, etc.

The system can use pre-filtering module 410 (e.g., filtering the domains based on the VirusTotal score) to reduce the workload.

In response to the new records being pre-filtered (e.g., by pre-filtering module 410, system 400 analyzes the remaining records to identify candidate domains to be evaluated. For example, if system 400 is configured as a pipeline for classifying non-rentable domains, system 400 obtains the pre-filtered domains and uses candidate selection module 420 to select the non-rentable domains to be classified from the pre-filtered domains. Conversely, if system 400 is configured as a pipeline for classifying rentable domains, system 400 obtains the pre-filtered domains and uses candidate selection module 420 to select the rentable domains to be classified from the pre-filtered domains.

In some embodiments, the functionality of candidate selection module 420 can be in pre-filtering module 410.

Candidate selection module 420 may be configured to additionally pre-process the domains (e.g., pre-process the URLs for the domains). Candidate selection module 420 obtains the URLs for the pre-filtered domains and identifies the corresponding host and registered domains. In some embodiments, if the registered domain is a rentable service (e.g. weebly.com, github.com, dropbox.com), the system risk score is calculated at subdomain level. Otherwise, if the registered domain is a non-rentable service, the risk score is calculated at the registered domain level.

According to various embodiments, system 400 determines whether a domain is a rentable domain or a non-rentable domain based at least in part on one or more of (a) a volume of subdomains created with respect to the particular over time; (b) a popularity of the subdomain; (c) a diversity of the content of the subdomains; (d) a diversity of the subdomain names; and (e) a historical diversity in the maliciousness of subdomains. Various other characteristics/factors may be used in connection with determining whether a domain is rentable or non-rentable.

System 400 performs feature extraction with respect to a set of candidate domains, such as those domains deemed to be candidate domains by a candidate selection process (e.g., by candidate selection module 420). In response to obtaining the candidate domains, system 400 uses feature extraction module 430 to extract a set of features pertaining to the candidate records (e.g., the candidate domains). System 400 uses the set of features in connection with obtaining machine learning predictions. In the example shown, feature extraction module 430 obtains domain data from domain dataset 425 and uses such domain data in connection with performing the feature extraction.

According to various embodiments, the set of features comprises one or more of (i) one or more features pertaining to pDNS data, (ii) one or more features pertaining to crawled content, (iii) one or more features pertaining to lexical data, (iv) one or more features pertaining to registration data, and (vi) one or more features pertaining to historical risk scores. Examples of one or more features comprised in the set of features are shown in Tables 1-6.

System 400 uses a classifier to predict whether a domain is likely to become malicious in the near future or within a predefined time period. The classifier predicts the likelihood that the domain will become malicious in the near future or within the predefined time period by generating a risk score. The risk score may be a value between 0 and 1. A higher the score (e.g., a risk score closer 1) is indicative that a domain is deemed riskier (e.g., relatively higher risk). As an example, the machine learning model is a trained model. System 400 uses prediction module 440 to generate the prediction (e.g., of whether the domain is a hijacked domain). Prediction module 440 uses the set of features extracted by the feature extraction module 430.

In the example shown, prediction module 440 obtains the prediction for a particular domain(s) by querying trained ML model 450 based at least in part on the set of features extracted from feature extraction module 430.

The system uses the set of extracted features as inputs to a classifier (e.g., a trained machine learning model). For example, for each record, system 400 generates a feature vector that is based at least in part on the set of features for that record (e.g., the domain). The feature vector is used to query the classifier. For example, the classifier obtains the feature vector and outputs a probability between 0 and 1 (e.g., 0 representing a prediction that the domain is not likely to become malicious within a predefined time period, and 1 representing a prediction that the domain is likely to become malicious within a predefined time period). During the training and testing of the classifier (e.g., the machine learning model), the system calculates the threshold that provides the best precision for prediction while maintaining the recall performance of the classifier (e.g., the machine learning model). To set threshold, the system is configured with a desired precision, and trains and tests the model on samples until the proper threshold that provides that precision is obtained.

Although machine learning models generally provide a prediction with a high confidence, the models can still be prone to false positives. Therefore, in some embodiments, system 400 uses a post-filtering to improve the risk score predictions. The post-filtering module 460 can implement a rule-based post-filtering. Example rules include (a) the number of pDNS queries to the domain is more than 1000, (b) the domain was registered more than 2 years ago, (c) the domain is in the Tranco top 100K list, (d) the domain was created more than two (2) years ago and is still active; (e) the domain was queried more than 1000 times in the last thirty (30) days and is still active; and (f) the domain is the Tranco 100K list or other third party service for popular or highly ranked domains.

In some embodiments, post-filtering module 460 implements a classifier. The classifier can be a rule-based classifier, a heuristics-based classifier, a machine learning-based classifier, or any combination thereof.

According to various embodiments, the system implements a machine learning model to determine (e.g., generate) a database of high or medium-risk domains. For example, the database can store a mapping of domains to predicted risk scores. The system uses the risk scores to classify the domains as low risk, medium risk, or high risk. In some embodiments, the system periodically (e.g., according to a predefined frequency) updates the database of high or medium-risk domains.

In some embodiments, the system uses an offline classifier (e.g., model) to generate the predictions of risk scores or classifications for the domains. The system builds a database of high, medium and low risk domains based on the domains and URLs observed from various active feeds. The process for classifying the domains and generating/updating the database include (a) stream URL/domain information from various feeds including Passive DNS, VirusTotal, Newly Registered Domains (NRDs), or other third party services; (b) filter out those domains that are deemed to have a high reputation based on their sustained popularity and mark them as low risk; (c) obtain the risk score from the offline ML model for risk scoring; (d) determine whether the risk score is greater than a first predefined risk threshold (e.g., t1); (e) set (e.g., classify) the domain as high risk if the risk score is above first predefined risk threshold (e.g., a value closer to 1); (f) set (e.g., classify) the domain as medium risk if the risk score is greater than a second predefined risk threshold (e.g., t2) but less than the first predefined risk threshold (where t2<t1); (g) set (e.g., classify) the domain as low risk if the risk score is below the second predefined threshold; (h) save the classifications of the domains in association with the domains in a database (e.g., the domains along with their risk scores and meta-data related to the model input and output are saved to the database); and (i) use the database to perform lookups to obtain the risk score for a particular domain, if the domain has already been evaluated/classified and an associated risk score has been determined.

According to various embodiments, the system provides a real-time detection/classification of URLs for domains having a risk score above a predefined threshold, such as domains classified as high risk, or domains classified as medium or high risk. The system can be implemented inline (e.g., at an inline security entity) to provide inline detections/classifications (e.g., classifications contemporaneous with the interception or handling of traffic to the domain).

In some embodiments, the system uses an inline classifier (e.g., model) to identify traffic to domains classified as high risk or medium risk, and to generate the malicious classifications in connection with determining how to handle the traffic. The process for classifying the domains includes (a) obtain the domain from the URL being accessed (e.g., determine the domain for the intercepted traffic sample); (b) determine whether the database of precomputed risk scores (e.g., by the offline model) has a record of the domain; (c) pass the request/traffic sample to the inline machine learning model if a risk score for the domain is not stored in the database of precomputed risk scores; (d) if the risk level (e.g., risk score stored in the database of precomputed risk scores) for the domain is high or medium, forward the URL to the inline content based detectors; and (e) handle the traffic based at least in part on the verdict from the inline content based detectors (e.g., based on the verdict from the these detectors, the device attempting to access the domain is provided either the original content from the URL or a blocked content notification).

According to various embodiments, the system provides a real-time prediction of a risk level associated with a domain or URL. For example, the system generates a real-time risk score prediction using an inline classifier (e.g., a lightweight ML model). The system can be implemented inline (e.g., at an inline security entity) to provide inline predicted risk scores (e.g., predictions contemporaneous with the interception or handling of traffic to the domain).

In some embodiments, the system obtains an intercepted traffic sample, determines an associated URL, and determines whether the domain associated with the URL has been previously evaluated/classified and an associated risk score or risk level is stored in a precomputed risk score database. If the system determines that the database does not have a record for the domain, the system can queue an offline analysis of the particular domain. However, in order to make a real-time decision on how to handle the traffic, the system can compute a risk score in real-time. The system computes a risk score (e.g., generates a predicted risk score) in real-time (e.g., contemporaneous with intercepting and handling the traffic) by using an line classifier (e.g., an inline ML model). The inline model can be a light-weight model of the offline model. In other words, the inline model relies only on those features that can be extracted real-time with a low response time. The process for predicting risk scores in real-time includes (a) extracting the lightweight features needed for the inline ML model for risk scoring, (b) obtaining the risk score from the model, (b) causing the URL/domain to be analyzed using the inline content-based detectors if the risk score is above a predefined risk threshold (e.g., a third predefined risk threshold, t3); and (c) handle the traffic based at least in part on the verdict from the inline content based detectors.

FIG. 5 is a flow diagram of a method for identifying higher-risk websites according to various embodiments. In some embodiments, process 500 is implemented at least in part by system 100 of FIG. 1. Process 500 may be implemented by an inline security entity and/or one or more servers that provide contemporaneous and/or offline classifications/detections.

At 505, the system identifies a subset of higher risk websites based on using a classifier. The system can identify the subset of higher risk websites by querying a machine learning model to generate a predicted risk score for the website/domain. The system can then classify the domain as low risk, medium risk, or high risk (or perform another classification) based at least in part on the predicted risk score.

At 510, the system performs an active measure. The active measure can include providing an indication of the classification of higher risk websites, updating a blacklist of websites, causing the website to be classified. The causing the website to be classified can include (i) querying a content-based detector (e.g., a machine learning model that classifies the website as benign or malicious based on the content hosted at the website), (ii) querying another classifier or machine learning model to generate a predicted classification of whether the website is malicious, etc.

At 515, the system determines whether process 500 is complete. In some embodiments, process 500 is determined to be complete in response to a determination that no further domains or websites are to be analyzed (e.g., no further predictions for domains are needed or requested), an administrator indicates that process 500 is to be paused or stopped, etc. In response to a determination that process 500 is complete, process 500 ends. In response to a determination that process 500 is not complete, process 500 returns to 505.

FIG. 6 is a flow diagram of a method for classifying a domain according to various embodiments. In some embodiments, process 600 is implemented at least in part by system 100 of FIG. 1.

In some implementations, process 600 may be implemented by one or more servers, such as in connection with providing a service to a network (e.g., a security entity and/or a network endpoint such as a client device). In some implementations, process 600 may be implemented by a security entity (e.g., a firewall) such as in connection with enforcing a security policy with respect to traffic from/to domains across a network or in/out of the network. In some implementations, process 600 may be implemented by a client device such as a laptop, a smartphone, a personal computer, etc., such as in connection with executing or opening a file such as an email attachment.

At 605, the system obtains a set of records. The system queries a pDNS dataset for the pDNS data/records for the set of records.

At 610, the system selects a candidate domain(s) from the domains associated with the set of records. In some embodiments, the system selects candidate domains based at least in part on a determination of whether the domain is a rentable domain or a non-rentable domain. The system can select the candidate domain based on the type of detection pipeline being performed and the determination of whether the domain is rentable or non-rentable.

At 615, the system extracts a set of features from information pertaining to the candidate domain(s). In some embodiments, the system extracts one or more of the features listed in Tables 1-6. Various combinations of features may be implemented. For example, at least a subset of features from more than one of Tables 1-6 may be implemented. Various alternative or additional features may be implemented.

At 620, the system uses a classifier to obtain a prediction(s) of whether the candidate domain(s) are higher risk websites (e.g., websites having a corresponding risk score above a predefined threshold). In some embodiments, the classifier is a machine learning-based classifier (e.g., a machine learning model trained using a machine learning process).

At 625, the system performs a post-filtering on the prediction(s) to obtain a classification(s) for the candidate domain(s). In some embodiments, the post-filtering is performed at least for offline classifications. The inline classification service may not implement a post-filtering because of the latency that a post-filtering may invoke (e.g., because the post-filtering may include querying a third party service, obtaining historical data, or crawling the webpage to obtain information to perform the post-filtering).

According to various embodiments, the system implements a post-filtering to increase the confidence of the verdicts (e.g., the classifications, risk scores, etc.), particularly to reduce the number of potential false positives.

At 630, the system provides an indication of the classification(s). For example, the system returns the indication of the set of features to the system or service that invoked process 600. In some embodiments, the indication is the risk score for the particular domain(s) or a risk level (e.g., low, medium, or high, which can be determined based on a risk score) for the particular domain(s). Additionally, or alternatively, the system stores the classification in a database (e.g., a precomputed verdict database that maps domains or identifiers of domains to classifications, such as computed risk scores). For example, the system stores a list of higher risk websites or a mapping of domains to risk level. In some embodiments, the system can provide the indication the classification(s) based on updating a whitelist, blacklist, or other lists or feed based on the classifications and deploying the whitelist, blacklists, or other lists or feeds at other network nodes, such as inline security entities or client systems.

At 635, the system determines whether process 600 is complete. In some embodiments, process 600 is determined to be complete in response to a determination that no further domains are to be analyzed (e.g., no further predictions for domains are needed or requested), no further resource records are obtained, no further traffic is to be classified, an administrator indicates that process 600 is to be paused or stopped, etc. In response to a determination that process 600 is complete, process 600 ends. In response to a determination that process 600 is not complete, process 600 returns to 605.

FIG. 7 is a flow diagram of selecting and using a classifier to classify a domain according to various embodiments. In some embodiments, process 700 is implemented at least in part by system 100 of FIG. 1. Process 700 may be invoked by process 600, such as at 620.

In some implementations, process 700 may be implemented by one or more servers, such as in connection with providing a service to a network (e.g., a security entity and/or a network endpoint such as a client device). In some implementations, process 700 may be implemented by a security entity (e.g., a firewall) such as in connection with enforcing a security policy with respect to traffic from/to domains across a network or in/out of the network. In some implementations, process 700 may be implemented by a client device such as a laptop, a smartphone, a personal computer, etc., such as in connection with executing or opening a file such as an email attachment.

At 705, the system obtains an indication to classify a candidate domain. As an example, indication to classify the domain (e.g., compute a risk score for the domain) can be associated with the classification of the domain in near real time, such by an inline security entity in connection with the determining how to handle intercepted traffic. As another example, the indication to classify the domain can be associated with a periodic offline classification process in which the system generates/updates a database of risk levels or risk scores associated with a set of domains.

At 710, the system obtains information pertaining to the candidate domain.

At 715, the system selects a classifier based at least in part on the information pertaining to the candidate domain. The system can determine whether the domain is a rentable domain, or a non-rentable domain based at least in part on the information pertaining to the candidate. In response to determining whether the domain is rentable or non-rentable, the system selects the applicable classifier (e.g., ML model) to be used to classify (e.g., predict a risk score or risk level) for the candidate domain.

At 720, the system uses the selected classifier to classify the candidate domain.

At 725, the system provides an indication of the classification for the candidate domain. For example, the system returns the indication of the set of features to the system or service that invoked process 700. Additionally, or alternatively, the system stores the classification in a database (e.g., a precomputed verdict database that maps domains or identifiers of domains to classifications, such as computed risk scores). In some embodiments, the system can provide the indication the classification(s) based on updating a whitelist, blacklist, or other lists or feed based on the classifications and deploying the whitelist, blacklists, or other lists or feeds at other network nodes, such as inline security entities or client systems.

At 730, the system determines whether process 700 is complete. In some embodiments, process 700 is determined to be complete in response to a determination that no further domains are to be analyzed (e.g., no further predictions for domains are needed or requested), no further resource records are obtained, no further traffic is to be classified, an administrator indicates that process 700 is to be paused or stopped, etc. In response to a determination that process 700 is complete, process 700 ends. In response to a determination that process 700 is not complete, process 700 returns to 705.

FIG. 8 is a flow diagram of a method for selecting a classifier to classify a domain according to various embodiments. In some embodiments, process 800 is implemented at least in part by system 100 of FIG. 1.

In some implementations, process 800 may be implemented by one or more servers, such as in connection with providing a service to a network (e.g., a security entity and/or a network endpoint such as a client device). In some implementations, process 800 may be implemented by a security entity (e.g., a firewall) such as in connection with enforcing a security policy with respect to traffic from/to domains across a network or in/out of the network. In some implementations, process 800 may be implemented by a client device such as a laptop, a smartphone, a personal computer, etc., such as in connection with executing or opening a file such as an email attachment.

At 805, the system obtains an indication to select a classifier.

At 810, the system obtains information pertaining to the candidate domain.

At 815, the system determines whether the candidate domain is a rentable domain.

For example, the system determines whether the candidate domain is a rentable or a registered domain based on the number of subdomains created in the recent past and the diversity of the content in the subdomains. In response to determining that the candidate domain is rentable, process 800 proceeds to 820. Conversely, in response to determining that the candidate domain is not rentable, process 800 proceeds to 825.

In some embodiments, the system uses data pertaining to subdomains in connection with querying a rentable domain classifier, and the system uses data pertaining to the registered domain (e.g., the root domain) in connection with querying a non-rentable domain classifier.

At 820, the system determines to use a rentable domain classifier as the selected classifier. In some embodiments, the system additionally determines whether to use an inline rentable domain classifier (e.g., a lightweight ML model) or an offline rentable domain classifier (e.g., a heavier ML model). The inline rentable domain classifier can provide quick predicted classifications, such as in less than 100 ms. For example, the inline rentable domain classifier provides a predicted classification contemporaneous with the interception and/or handling of network traffic. The offline rentable domain classifier can be used to provide asynchronous classifications, such as periodic classifications used to determine precomputed verdicts. In some embodiments, the offline rentable domain classifier is trained using more features than the number of features used to train the inline rentable domain classifier. Additionally, or alternatively, the offline rentable domain classifier can implement one or more features that are determined by querying a third party service for historical data.

At 825, the system determines to use a non-rentable domain classifier as the selected classifier. In some embodiments, the system additionally determines whether to use an inline non-rentable domain classifier (e.g., a lightweight ML model) or an offline non-rentable domain classifier (e.g., a heavier ML model). The inline non-rentable domain classifier can provide quick predicted classifications (e.g., predicted risk scores), such as in less than 100 ms. For example, the inline non-rentable domain classifier provides a predicted classification contemporaneous with the interception and/or handling of network traffic. The offline non-rentable domain classifier can be used to provide asynchronous classifications, such as periodic classifications used to determine precomputed verdicts. In some embodiments, the offline non-rentable domain classifier is trained using more features than the number of features used to train the inline non-rentable domain classifier. Additionally, or alternatively, the offline non-rentable domain classifier can implement one or more features that are determined by querying a third party service for historical data.

FIG. 9 is an illustration of an inference pipeline for determining risk scoring for a set of domains according to various embodiments. In the example shown, system 900 obtains domain information from one or more data sources. For example, system 900 obtains VirusTotal URL data from a VirusTotal URL feed 905, URL data from a security service URL feed 915 (e.g., URLs processed/detected by a security service, such as an in-house URL feed), and/or a stream/feed of URLs from various other services. System 900 can obtain URLs from the one or more data sources at predefined intervals/frequencies, or in response to a particular predefined criteria being satisfied. In response to receiving the URLs (or other indications of domains), system 900 can pre-filter the URLs to reduce the number of URLs to be classified (e.g., for which a risk score is to be predicted). System 900 can pre-filter the URLs to ensure that only those URLs having some predefined malicious or suspicious indicators are evaluated/classified by the inference pipeline. For example, system 900 uses pre-filtering service 910 to pre-filter the URLs identified from the VirusTotal URL feed 905. Pre-filtering service 910 can filter out those URLs having a corresponding VirusTotal score less than a predefined threshold, for example, URLs having VirusTotal hits less than 1. However, various other thresholds can be implemented to change the sensitivity of pre-filtering service 910. Similarly, system 900 uses pre-filtering service 920 to filter URLs from the security service URL feed 915. For example, pre-filtering service 920 filters the URLs to filter out non-malicious URLs (e.g., URLs which were not known to be malicious or previously classified as malicious).

After system 900 pre-filters the URLs, system 900 uses URL processing service 930 to process the URLs resulting from the pre-filtering operation. URL processing service 930 can query one or more data sources or third party services for domain information for the URLs to be processed. The domain information can be used to identify whether the URL is associated with a rentable domain or a non-rentable domain, which can then be used to select the appropriate classifier. For example, URL processing service 930 obtains these URLs and identifies the corresponding host and registered domains. If the registered domain is a rentable service (e.g. weebly.com, github.com, dropbox.com), the risk score is calculated at subdomain level. Otherwise, if the registered domain is not a rentable service, the risk score is calculated at the registered domain level.

The obtained domain information can include sufficient information for system 900 to determine whether the domain is a rentable domain or a non-rentable domain. For example, system 900 can determine one or more of the following based on the domain information (i) a volume of subdomains created over time; (ii) a popularity of subdomains; (iii) a diversity of the content of the subdomains; (iv) a diversity of the subdomain names; and (v) a historical diversity in the maliciousness of subdomains. Example rules that can be implemented in connection with determining whether a domain is rentable or non-rentable include (a) the number of pDNS queries to the domain is more than 1000, (b) the domain was registered more than 2 years ago, and (c) the domain is in the Tranco top 100K list.

In response to obtaining the domain information, system 900 can use rentable service detector 935 to determine whether the corresponding domain is a rentable domain or a non-rentable domain based at least in part on the domain information. Rentable service detector 935 can implement a predefined algorithm or process for classifying the domain as rentable versus non-rentable.

According to various embodiments, system 900 implements different classifiers based on whether the domain to be classified (e.g., for which a risk score is to be predicted) is a rentable domain or non-rentable domain. For example, rentable domains and non-rentable domains can have a relatively large different set of characteristics, and thus for greater accuracy the system uses different classifiers specifically configured for the particular type of domain.

After classifying the domain as rentable or non-rentable, system 900 extracts features for the domain. If the domain is determined to be a rentable domain, system 900 uses subdomain feature extractor 940 to extract features for the domain. Conversely, if the domain is determined to be a non-rentable domain, system 900 uses registered domain feature extractor 950 to extract features for the domain.

After a set of features is extracted for the domain, system 900 uses the applicable classifier to classify the domain, such as by generating a predicted risk score or predicting a risk level for the domain. If the domain is a rentable domain, system 900 uses host classifier 945 to classify the domain based at least in part on a set of features extracted by subdomain feature extractor 940. Conversely, if the domain is not a rentable domain, system 900 uses registered domain classifier 955 to classify the domain based at least in part on a set of features extracted by registered domain feature extractor 950.

Host classifier 945 computes a risk score for rentable subdomains and registered domain classifier 955 computes a risk score for registered domains. In some embodiments, the host classifier 945 does not use WHOIS registration features at least in part because the reputations of the rentable registered domains are generally not indicative of the reputation of the subdomains. According to various embodiments, based on the thresholds established at the training time to achieve the desired false positive rates, each classifier marks the domains as low, medium or high risk in addition to providing the risk score between 0 and 1.

Domains deemed to be high risk domains (e.g., domains for which system 900 determines the predicted risk score exceeds a predefined threshold) are sent through a post-filtering service 960. The post-filtering service 960 can check/confirm that the predicted classifications are not false positive and filters out classifications/detections that are expected to be (e.g., likely to be) false positive (FP) classifications. In some embodiments, post-filtering service 960 uses one or more predefined rules to exclude potential FPs. For example, if any of the one or more predefined rules is true, the domain is not classified as high risk. The rationale is that the one or more predefined rules in general represent domains with moderate to high reputation. Examples of a predefined rule that can be used to filter out FPs include (a) the domain was created more than two (2) years ago and is still active; (b) the domain was queried more than 1000 times in the last thirty (30) days and is still active; and (c) the domain is the Tranco 100K list or other third party service for popular or highly ranked domains.

In response to post-filtering the classifications to remove those classifications expected to be false positives, system 900 stores the classifications (e.g., the predicted risk scores or risk levels) in a verdict database 965.

According to various embodiments, the inline classifier (e.g., ML model) is similar to the offline model classifier. However, the inline classifier may be configured to use only those features that are relatively easy to collect or that do not otherwise introduce relatively significant latency in the classification prediction (e.g., that would cause classifications to take longer than 100 ms or some other predefined time threshold).

In some embodiments, the inline classifier does not implement passive DNS (pDNS) features. The computation of pDNS features is time consuming, such as because the system generally queries a third party service for pDNS data required to compute the pDNS features.

In some embodiments, the inline classifier implements some crawled content features. For example, the inline classifier implements one or more of the crawled content features provided in Table 2. However, the inline classifier does not implement some crawled content features that are difficult to compute or introduce infeasible latency into the classification. For example, the inline classifier may not implement features computed based at least in part on the malicious crawl percentage.

In some embodiments, the inline classifier implements lexical features. For example, the inline classifier implements one or more of the lexical features provided in Table 3.

In some embodiments, the inline classifier implements some registration features. For example, the inline classifier implements one or more of the registration features provided in Table 4. Examples of registration features that may be implemented by inline classifier include (a) registration features based at least in part on a registrar reputation score; (b) registration features based on a duration of the domain registration; (c) registration features based at least in part on a number of days since the registration was last updated; (d) registration features based at least in part on a number of name servers; (e) registration features based on a determination that the domain is privacy protected.

In some embodiments, the inline classifier implements VirusTotal report features. For example, the inline classifier implements one or more of the VirusTotal report features provided in Table 5.

In some embodiments, the inline classifier does not implement historical risk score-based features. For example, the inline classifier does not implement one or more of the historical risk score-based features provided in Table 6. The historical risk score-based feature may be infeasible to compute inline with the interception or handling of traffic because the classifier would have to obtain historical domain information to generate such features.

The inline model can be trained very similarly to the training of the offline model. Because the inline model is trained with a fewer number of easy to collect features, the inline model performance is slightly lower than that of the offline model. However, the inline model generates the predicted classification with less latency.

FIG. 10 is a flow diagram of a method for using a classifier to predict a domain classification according to various embodiments. In some embodiments, process 1000 is implemented at least in part by system 100 of FIG. 1.

In some implementations, process 1000 may be implemented by one or more servers, such as in connection with providing a service to a network (e.g., a security entity and/or a network endpoint such as a client device). In some implementations, process 1000 may be implemented by a security entity (e.g., a firewall) such as in connection with enforcing a security policy with respect to traffic from/to domains across a network or in/out of the network. In some implementations, process 1000 may be implemented by a client device such as a laptop, a smartphone, a personal computer, etc., such as in connection with executing or opening a file such as an email attachment.

At 1005, the system obtains an indication to classify a candidate domain.

At 1010, the system obtains information pertaining to the candidate domain.

At 1015, the system extracts features for the candidate domain. The system can extract a set of features based at least in part on the obtained information pertaining to the candidate domain. Further, the set of features to be extracted is based at least in part on the classifier implemented to classify the candidate domain, such as based on whether the domain is rentable or non-rentable, or whether the classification is provided inline with the interception/handling of traffic or offline in connection with generating/updating a mapping of domain classifications.

At 1020, the system queries a classifier for a predicted classification based at least in part on the extracted features.

At 1025, the system obtains a predicted classification based at least in part on a result from the classifier.

At 1030, the system provides the predicted classification. For example, the system returns the indication of the predicted classification to the system or service that invoked process 1000. The predicted classification may be a predicted risk score. Alternatively, the predicted classification may be a risk classification (e.g., low risk, medium risk, or high risk), which can be determined based on a predefined mapping of risk score ranges to risk classifications. For example, a low risk classification may be mapped to a risk score range of 0 to 0.3; a medium risk classification may be mapped to a risk score range of 0.3 to 0.7; and a high risk classification may be mapped to a risk score range of 0.7 to 1.

Additionally, or alternatively, the system stores the classification in a database (e.g., a precomputed verdict database that maps domains or identifiers of domains to classifications, such as computed risk scores). In some embodiments, the system can provide the indication the classification(s) based on updating a whitelist, a blacklist, or other lists or feed based on the classifications and deploying the whitelist, blacklists, or other lists or feeds at other network nodes, such as inline security entities or client systems.

At 1035, the system determines whether process 1000 is complete. In some embodiments, process 1000 is determined to be complete in response to a determination that no further domains are to be analyzed (e.g., no further predictions for domains are needed or requested), no further traffic is to be classified, an administrator indicates that process 1000 is to be paused or stopped, etc. In response to a determination that process 1000 is complete, process 1000 ends. In response to a determination that process 1000 is not complete, process 1000 returns to 1005.

FIG. 11 is a flow diagram of a method for performing inline classification of a domain according to various embodiments. In some embodiments, process 1100 is implemented at least in part by system 100 of FIG. 1. Process 1100 may be invoked by process 600, such as at 625.

In some implementations, process 1100 may be implemented by one or more servers, such as in connection with providing a service to a network (e.g., a security entity and/or a network endpoint such as a client device). In some implementations, process 1100 may be implemented by a security entity (e.g., a firewall) such as in connection with enforcing a security policy with respect to traffic from/to domains across a network or in/out of the network. In some implementations, process 1100 may be implemented by a client device such as a laptop, a smartphone, a personal computer, etc., such as in connection with executing or opening a file such as an email attachment.

At 1105, the system obtains a candidate sample to be classified. The system can obtain the candidate sample from intercepted network traffic. For example, an inline security entity intercepts network traffic and identifies a candidate domain to/from which the traffic is communicated.

At 1110, the system determines whether the candidate sample is comprised in a precomputed verdict database. The system can query the precomputed verdict database to determine whether the precomputed verdict database comprises a record associated with the candidate domain. For example, the system can query the precomputed verdict database based at least in part on the candidate domain or another identifier or representation of the candidate domain, such as a hash computed according to a predefined hashing technique.

In some embodiments, the precomputed verdict database stores a mapping of domains (or identifiers for the domains) to a predicted risk score, such as a value between 0 and 1, with 0 being more benign and 1 being higher risk. Alternatively, the precomputed verdict database stores a mapping of domains (or identifiers for the domains) to risk classifications (e.g., qualitative classifications such as low risk, medium risk, or high risk).

In response to determining that the precomputed verdict database comprises the candidate sample, process 1100 proceeds to 1115 at which the system obtains the precomputed classification from the precomputed verdict database.

Conversely, in response to determining that the precomputed verdict databased does not comprise the candidate sample, process 1100 proceeds to 1120 at which the system obtains information pertaining to the candidate domain. For example, the system determines that a classification is to be generated and thus obtains the information to use in connection with querying the applicable classifier (e.g., an inline classifier, which may be an inline rentable domain classifier or an inline non-rentable domain classifier).

At 1125, the system extract features for the candidate domain. The system can extract a set of features based at least in part on the information pertaining to the candidate domain. In some embodiments, the system determines the classifier or type of classifier (e.g., rentable domain classifier versus non-rentable domain classifier and/or an inline classifier versus an offline classifier) and determines the features to be extracted based at least in part on the classifier to be used to classify the candidate domain.

At 1130, the system queries an inline classifier for a predicted classification based at least in part on the extracted features. The inline classifier may be a classifier configured to classify rentable domains, or a classifier configured to classify non-rentable domains. The system can select the appropriate inline classifier based at least in part on a determination of whether the candidate domain is rentable or non-rentable.

At 1135, the system provides the classification. For example, the system returns the indication of the predicted classification to the system or service that invoked process 1100. The predicted classification may be a predicted risk score. Alternatively, the predicted classification may be a risk classification (e.g., low risk, medium risk, or high risk), which can be determined based on a predefined mapping of risk score ranges to risk classifications. For example, a low risk classification may be mapped to a risk score range of 0 to 0.3; a medium risk classification may be mapped to a risk score range of 0.3 to 0.7; and a high risk classification may be mapped to a risk score range of 0.7 to 1.

Additionally, or alternatively, the system stores the classification in a database (e.g., a precomputed verdict database that maps domains or identifiers of domains to classifications, such as computed risk scores). In some embodiments, the system can provide the indication the classification(s) based on updating a whitelist, blacklist, or other lists or feed based on the classifications and deploying the whitelist, blacklists, or other lists or feeds at other network nodes, such as inline security entities or client systems.

At 1140, the system determines whether process 1100 is complete. In some embodiments, process 1100 is determined to be complete in response to a determination that no further domains are to be analyzed (e.g., no further predictions for domains are needed or requested), no further traffic is to be classified, an administrator indicates that process 1100 is to be paused or stopped, etc. In response to a determination that process 1100 is complete, process 1100 ends. In response to a determination that process 1100 is not complete, process 1100 returns to 1105.

FIG. 12 is a flow diagram of a method for training a model according to various embodiments. In some embodiments, process 1200 is implemented at least in part by system 100 of FIG. 1.

At 1205, the system obtains information pertaining to a set of historical malicious domains. In some embodiments, the system obtains the information pertaining to a set of historical known malicious domains known internally or from a third-party service (e.g., VirusTotal™). The system may obtain a set of historical samples of malicious campaigns from a third party service.

At 1210, the system obtains information pertaining to a set of historical known non-malicious domains (e.g., benign domains). In some embodiments, the system obtains the information pertaining to a set of historical known benign domains from a third-party service (e.g., VirusTotal™).

At 1215, the system determines one or more relationships between characteristic(s) of domains and indications that the candidate domains are malicious domains. For example, the system determines a set of features to be used by a classifier (e.g., a machine learning model) to classify candidate domains.

At 1220, the system trains a model for predicting a risk score or risk classification for a candidate domain. The model is trained based at least in part on one or more relationships between characteristic(s) of domains and indications that the candidate domains are malicious domains. The model may be a machine learning model. For example, the model is trained using a machine learning process. The model can be a random-forest machine learning model.

In some embodiments, the system trains an offline model and an inline model, where the offline model implements a greater number of features, and the inline model uses some precomputed features and/or features for a smaller number of domains (e.g., the inline model may be limited to monitored domains, popular domains, customer domains, etc.). Additionally, or alternatively, the system trains a rentable domain classifier for predicting risk scores or risk classifications for a candidate domain that is a rentable domain and/or non-rentable domain classifier for predicting risk scores or risk classifications for a candidate domain that is a non-rentable domain.

In some embodiments, the system trains one or more of: (a) an inline rentable domain classifier, (b) an inline non-rentable domain classifier, (c) an offline rentable domain classifier, and/or (d) an offline non-rentable domain classifier.

Examples of machine learning processes/techniques that can be implemented in connection with training the model include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, etc.

At 1225, the system deploys the model. In some embodiments, the deploying of the model includes storing the model in a dataset of models for use in connection with analyzing candidate domains, such as candidate domains obtained from intercepted traffic, to determine a risk score (e.g., between 0 and 1) or a risk classification (e.g., low risk, medium risk, or high risk, etc.). Deploying the model can include providing the model (or a location at which the model can be invoked) to a malicious traffic detector, such as domain classifier 170 of system 100 of FIG. 1. In some embodiments, in the case of an inline domain classifier, the system can provide the model to an inline security entity to perform inline evaluations/classifications (e.g., contemporaneous with interception or handling of network traffic).

At 1230, a determination is made as to whether process 1200 is complete. In some embodiments, process 1400 is determined to be complete in response to a determination that no further models are to be determined/trained (e.g., no further classification models are to be created), an administrator indicates that process 1200 is to be paused or stopped, etc. In response to a determination that process 1200 is complete, process 1200 ends. In response to a determination that process 1200 is not complete, process 1200 returns to 1205.

FIG. 13 is a flow diagram of a method for performing inline classification of a domain according to various embodiments. In some embodiments, process 1300 is implemented at least in part by system 100 of FIG. 1.

In some implementations, process 1300 may be implemented by one or more servers, such as in connection with providing a service to a network (e.g., a security entity and/or a network endpoint such as a client device). In some implementations, process 1300 may be implemented by a security entity (e.g., a firewall) such as in connection with enforcing a security policy with respect to traffic from/to domains across a network or in/out of the network. In some implementations, process 1300 may be implemented by a client device such as a laptop, a smartphone, a personal computer, etc., such as in connection with executing or opening a file such as an email attachment.

At 1305, the system obtains a candidate sample. The system can obtain the candidate sample from intercepted network traffic. For example, an inline security entity intercepts network traffic and identifies a candidate domain to/from which the traffic is communicated.

At 1310, the system determines whether the candidate sample is comprised in a precomputed verdict database. The system can query the precomputed verdict database to determine whether the precomputed verdict database comprises a record associated with the candidate domain. For example, the system can query the precomputed verdict database based at least in part on the candidate domain or another identifier or representation of the candidate domain, such as a hash computed according to a predefined hashing technique.

In some embodiments, the precomputed verdict database stores a mapping of domains (or identifiers for the domains) to a predicted risk score, such as a value between 0 and 1, with 0 being more benign and 1 being higher risk. Alternatively, the precomputed verdict database stores a mapping of domains (or identifiers for the domains) to risk classifications (e.g., qualitative classifications such as low risk, medium risk, or high risk).

In response to determining that the precomputed verdict databased does not comprise the candidate sample, process 1300 proceeds to 1330 at which the system determines a predicted classification for the candidate sample based at least in part on querying an inline classifier. The inline classifier may be selected based at least in part on whether the candidate sample is a rentable domain or a non-rentable domain.

In response to determining that the precomputed verdict database comprises the candidate sample, process 1300 proceeds to 1315 at which the system determines whether the risk is equal to or greater than a predefined threshold (e.g., a risk score threshold). In some embodiments, the system obtains the risk classification (e.g., the precomputed risk score) from the precomputed verdict database and compares the risk classification to a predefined threshold. Alternatively, the system can determine whether the risk classification satisfies a predefined criteria (e.g., the risk classification being deemed a high risk domain). If the risk (e.g., the risk classification) is less than predefined threshold, the system can determine not to further evaluate the domain. As an example, because evaluating every candidate domain associated with intercepted traffic can be computationally expensive, the system uses the risk score as a filtering technique to identify those domains for which the computationally expensive evaluation is to be performed. The system may further evaluate/classify only those domains deemed to be high risk (e.g., having a risk score exceeding a predefined risk score threshold), and may treat low risk domains as benign domains which are handled as normal traffic. The types or classifications of domains for which the system is to deem as a benign/non-malicious domain can be configurable (e.g., an administrator can set both low risk and medium risk domains to be handled as non-malicious traffic, etc.).

In response to determining that the risk equal to or greater than the predefined threshold, process 1300 proceeds to 1320 at which the system classifies the candidate sample as non-malicious.

In response to determining that the risk equal to or greater than the predefined threshold, process 1300 proceeds to 1325 at which the system classifies the sample based at least in part on implementing an inline content analysis. For example, the inline content analysis can include crawling the corresponding website and evaluating/classifying the sample based on the crawled data. As an example, the inline content analysis can identify an injected web skimmer or redirection to a malicious website Various other data or techniques can be used during the inline content analysis to determine whether the domain is malicious

At 1335, the system provides the classification. For example, the system returns the indication of the predicted classification to the system or service that invoked process 1300. The predicted classification may be an indication of whether the candidate sample is a malicious domain or a benign/non-malicious domain.

Additionally, or alternatively, the system stores the classification in a database (e.g., a precomputed verdict database that maps domains or identifiers of domains to classifications, such as computed risk scores). In some embodiments, the providing the indication the classification(s) includes updating a whitelist or blacklist based on the classifications and deploying the whitelist or blacklists at other network nodes, such as inline security entities or client systems.

At 1340, the system determines whether process 1300 is complete. In some embodiments, process 1300 is determined to be complete in response to a determination that no further domains are to be analyzed (e.g., no further predictions for domains are needed or requested), no further traffic is to be classified, an administrator indicates that process 1300 is to be paused or stopped, etc. In response to a determination that process 1300 is complete, process 1300 ends. In response to a determination that process 1300 is not complete, process 1300 returns to 1305.

FIG. 14 is a flow diagram of a process for using an inline classifier to perform inline classification of a domain according to various embodiments. In some embodiments, process 1400 is implemented at least in part by system 100 of FIG. 1. Process 1400 may be invoked by process 1300 of FIG. 13, such as at 1330.

In some implementations, process 1400 may be implemented by one or more servers, such as in connection with providing a service to a network (e.g., a security entity and/or a network endpoint such as a client device). In some implementations, process 1400 may be implemented by a security entity (e.g., a firewall) such as in connection with enforcing a security policy with respect to traffic from/to domains across a network or in/out of the network. In some implementations, process 1300 may be implemented by a client device such as a laptop, a smartphone, a personal computer, etc., such as in connection with executing or opening a file such as an email attachment.

At 1405, the system obtains an indication to classify a candidate domain using an inline classifier. For example, the system obtains the indication to classify the candidate domain in connection with process 1400 being invoked, such as by 1330 of process 1300.

At 1410, the system queries an inline classifier for a predicted classification. The system can obtain a set of features extracted from information pertaining to the candidate domain and query the inline classifier based at least in part on the set of features. In some embodiments, the inline classifier is selected based at least in part on a domain type to which the candidate domain corresponds. For example, the inline classifier is selected based at least in part on determination of whether the candidate domain is a rentable domain or a non-rentable domain. The system can determine whether the candidate domain is rentable and correspondingly select an inline classifier to be used to classify the candidate domain.

At 1415, the system uses the predicted classification to determine if risk is greater than or equal to a predefined threshold. In some embodiments, the system obtains the risk classification (e.g., the precomputed risk score) from the precomputed verdict database and compares the risk classification to a predefined threshold. Alternatively, the system can determine whether the risk classification satisfies a predefined criteria (e.g., the risk classification being deemed a high risk domain). If the risk (e.g., the risk classification) is less than predefined threshold, the system can determine not to further evaluate the domain. As an example, because evaluating every candidate domain associated with intercepted traffic can be computationally expensive, the system uses the risk score as a filtering technique to identify those domains for which the computationally expensive evaluation is to be performed. The system may further evaluate/classify only those domains deemed to be high risk (e.g., having a risk score exceeding a predefined risk score threshold), and may treat low risk domains as benign domains which are handled as normal traffic. The types or classifications of domains for which the system is to deem as a benign/non-malicious domain can be configurable (e.g., an administrator can set both low risk and medium risk domains to be handled as non-malicious traffic, etc.).

In response to determining that the risk is greater than or equal to the predefined threshold, process 1400 proceeds to 1420 at which the system classifies the candidate domain based at least in part on implementing an inline content analyzer. For example, the performing the inline content analysis can be implement the same technique described for 1325 of process 1300. The performing the inline content analysis includes performing an inline analysis of whether the domain is malicious or benign/non-malicious.

In response to determining that the risk is not greater than or equal to the predefined threshold, process 1400 proceeds to 1425 at which the system classifies the candidate domain as non-malicious.

At 1430, the system provides the classification. For example, the system returns the indication of the predicted classification to the system or service that invoked process 1400. The predicted classification may be an indication of whether the candidate domain is a malicious domain or a benign/non-malicious domain. Traffic to the candidate domain can be handled according to the classification. For example, traffic to/from a candidate domain classified as malicious can be handled in accordance with enforcement of a predefined security policy. As another example, traffic to/from a candidate domain classified as benign/non-malicious can be handled as normal traffic such as to allow the traffic to pass normally or uninterrupted.

At 1435, the system determines whether process 1400 is complete. In some embodiments, process 1400 is determined to be complete in response to a determination that no further domains are to be analyzed (e.g., no further predictions for domains are needed or requested), no further traffic is to be classified, an administrator indicates that process 1400 is to be paused or stopped, etc. In response to a determination that process 1400 is complete, process 1400 ends. In response to a determination that process 1400 is not complete, process 1400 returns to 1405.

FIG. 15 is a flow diagram of a method for detecting malicious traffic according to various embodiments. In some embodiments, process 1500 is implemented at least in part by system 100 of FIG. 1. Process 1500 may be implemented by an inline security entity.

In some implementations, process 1500 may be implemented by one or more servers, such as in connection with providing a service to a network (e.g., a security entity and/or a network endpoint such as a client device). In some implementations, process 1500 may be implemented by a security entity (e.g., a firewall) such as in connection with enforcing a security policy with respect to traffic from/to domains across a network or in/out of the network. In some implementations, process 1500 may be implemented by a client device such as a laptop, a smartphone, a personal computer, etc., such as in connection with executing or opening a file such as an email attachment.

At 1505, the system receives an indication of whether the candidate domain is high risk (or otherwise malicious). The indication of whether the candidate domain is high risk may comprise a risk score that indicates a severity of risk such as a value between 0 and 1, where 0 is benign/low-risk. Additionally, or alternatively, the indication of whether the candidate domain is high risk can comprise a risk type such as an indication that the candidate domain is low risk, medium risk, or high risk, etc.

In some embodiments, the system may receive the indication of whether the candidate domain is high risk (or otherwise malicious) from an offline risk classification pipeline, such as a pipeline using the techniques described herein.

In some embodiments, the indication of whether the candidate domain is high risk can be an indication that the candidate domain is malicious or benign/non-malicious. The indication that the candidate domain is a high risk is received in connection with an update to a set of previously identified malicious domains. For example, the system receives the indication that the candidate domain is a high risk domain as an update to a blacklist of malicious domains.

In some embodiments, the system receives an indication of a risk score computed for the candidate domain, and the domain or hash, signature, or other unique identifier associated with the domain. For example, the system may receive the indication that the domain is high risk or has a risk score equal to a particular value (e.g., a value between 0 and 1, where value closer to 1 has a relatively higher risk) from a service such as a security or malware service. The service implements an offline classification of domains, and can maintain a whitelist or blacklist of domains for inline handling.

At 1510, the system stores an association of the candidate domain with an indication of whether the domain is high risk (or is otherwise malicious, or conversely, benign/non-malicious). In response to receiving the indication that the candidate domain is high risk, the system stores the indication that the candidate domain is high risk (or otherwise malicious) in association with the domain or an identifier corresponding to the domain to facilitate a lookup (e.g., a local lookup) of whether subsequently received traffic is to/from malicious domains. In some embodiments, the identifier corresponding to the domain stored in association with the indication of whether the domain is high risk comprises a hash of the domain, a signature of the domain, or another unique identifier associated with the domain.

At 1515, the system receives traffic. The system may obtain traffic such as in connection with routing traffic within/across a network, or mediating traffic into/out of a network such as a firewall, or a monitoring of email traffic or instant message traffic. The traffic may be obtained based on the inline security entity monitoring application traffic or network traffic.

At 1520, the system determines whether the traffic is to/from a high risk or otherwise malicious domain. In some embodiments, the system obtains a candidate domain from the received traffic. In response to obtaining the candidate domain from the traffic, the system determines whether the candidate domain corresponds to a domain comprised in a set of previously identified high risk domains or otherwise malicious domains such as a blacklist of malicious domains. In response to determining that the candidate domain is comprised in the set of domains on the blacklist of malicious domains, the system determines that the domain is a high risk domain or otherwise malicious domain. The system can invoke a further inline classification for domains classified as high risk, such as by implementing the techniques of detection pipelines described in connection with processes 1300 and 1400.

In some embodiments, the system determines whether the candidate domain corresponds to a domain comprised in a set of previously identified benign domains such as a whitelist of benign domains. In response to determining that the candidate domain is comprised in the set of domains on the whitelist of benign domains, the system determines that the domain is not malicious. Alternatively, the system can obtain a precomputed risk score for the candidate domain, determine that the precomputed risk score corresponds to a low risk domain or otherwise satisfies a predefined criteria (e.g., has a risk score value less than a predefined risk score threshold), and handle traffic to/from the domain as benign/non-malicious, etc.

According to various embodiments, in response to determining the candidate domain is not comprised in a set of previously identified malicious domains (e.g., a blacklist of malicious domains) or a set of previously identified benign domains (e.g., a whitelist of benign domains), the system deems the domain as being non-malicious (e.g., benign). Alternatively, in response to determining that the candidate domain is not comprised in the mapping of domains to indications of the corresponding domain classification or risk score, the system can invoke an inline classification pipeline, such as by invoking process 1400 of FIG. 14.

According to various embodiments, in response to determining the candidate domain is not comprised in a set of previously identified malicious domains (e.g., a blacklist of malicious domains) or a set of previously identified benign domains (e.g., a whitelist of benign domains), the system queries a malicious domain detector (e.g., an inline risk classifier or maliciousness classifier) to determine whether the candidate domain is a high risk or additionally or alternatively, a malicious domain. For example, the system may quarantine traffic to/from the domain until the system receives response from the malicious domain detector as to whether the domain is (e.g., predicted to be) high risk or otherwise malicious. The malicious domain detector may perform an assessment of whether the candidate domain is high risk or otherwise malicious such as contemporaneous with the handling of the traffic by the system (e.g., in real-time with the query from the system). The malicious domain detector may correspond to domain classifier 170 of system 100 of FIG. 1.

In some embodiments, the system determines whether the candidate domain is comprised in the set of previously identified malicious domains or the set of previously identified benign domains by computing a hash or determining a signature or other unique identifier associated with the domain and performing a lookup in the set of previously identified malicious domains or the set of previously identified benign domains for a domain matching the hash, signature or other unique identifier. Various hashing techniques may be implemented.

In response to a determination that the traffic does not correspond to traffic to/from a high risk or malicious domain at 1520, process 1500 proceeds to 1530 at which traffic to/from the domain is handled as non-malicious traffic/information. Conversely, in response to a determination that the traffic corresponds to traffic to/from a high risk domain or malicious domain at 1520, process 1500 proceeds to 1525 at which traffic to/from the domain is handled as malicious traffic/information. The system may handle the malicious traffic/information based at least in part on one or more policies such as one or more security policies.

According to various embodiments, the handling of the malicious traffic/information (e.g., traffic to/from a malicious domain) may include performing an active measure. The active measure may be performed in accordance with (e.g., based at least in part on) one or more security policies. As an example, the one or more security policies may be preset by a network administrator, a customer (e.g., an organization/company) to a service that provides detection of malicious domains, etc. Examples of active measures that may be performed include: isolating the traffic to/from the malicious domain (e.g., quarantining the traffic), deleting the traffic, prompting the user to alert the user that a malicious domain was detected, providing a prompt to a user when the a device attempts to open access the domain, blocking transmission of information to/from the domain, updating a blacklist of malicious domains (e.g., a mapping of a hash for the domain to an indication that the candidate domain is malicious, etc.

At 1535, a determination is made as to whether process 1500 is complete. In some embodiments, process 1500 is determined to be complete in response to a determination that no further domains are to be analyzed (e.g., no further predictions for domains are needed), an administrator indicates that process 1500 is to be paused or stopped, etc. In response to a determination that process 1500 is complete, process 1500 ends. In response to a determination that process 1500 is not complete, process 1500 returns to 1505.

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
identify a subset of higher risk websites based on using a classifier, wherein the higher risk websites are at risk for potential malware injection or modification; and
in response to identifying the subset of higher risk websites, perform an active measure based at least in part on the identified subset of higher risk websites; and
a memory coupled to the one or more processors and configured to provide the one or more processors with instructions.

2. The system of claim 1, wherein the classifier is a machine learning model.

3. The system of claim 2, wherein the machine learning model comprises a random forest machine learning model.

4. The system of claim 1, wherein performing the active measure in response to determining that a candidate domain is comprised in the subset of higher risk websites comprises:
applying a security policy based on a classification of the candidate domain as being a higher risk website.

5. The system of claim 4, wherein applying the security policy comprises:
handling network traffic to/from the candidate domain based at least in part on (i) a classification that the candidate domain is a higher risk website, and (ii) the security policy.

6. The system of claim 1, wherein the active measure comprises storing a set of classifications for the subset of higher risk website in a domain classification database.

7. The system of claim 6, wherein the domain classification database is used to detect higher risk website and in response to detection of the higher risk website, enforcing a security policy for handling traffic to or from the higher risk website.

8. The system of claim 6, wherein the one or more processors are further configured to:
obtain a candidate sample to be classified;
infer a classification for the candidate sample based at least in part on querying the domain classification database; and
perform an action based at least in part on the classification for the candidate sample.

9. The system of claim 1, wherein the subset of higher risk websites comprises one or more subdomains and one or more registered domains.

10. The system of claim 1, wherein the classifier is used to provide real-time analysis of a risk level for a candidate domain associated with a URL.

11. The system of claim 10, wherein the classifier used to provide real-time analysis is a lightweight inline machine learning model.

12. The system of claim 11, wherein the lightweight inline machine learning model is trained using a fewer number of features than an offline machine learning model that provides offline detection or classification of websites.

13. The system of claim 1, wherein the subset of higher risk websites are periodically crawled at a more frequent rate than websites classified as benign or low or medium risk.

14. The system of claim 1, wherein the one or more processors are further configured to:
in response to classifying a candidate website as a higher risk website,
causing the candidate website to be crawled; and
causing the candidate website to be analyzed for malware based at least in part on results of crawling the candidate website.

15. The system of claim 1, wherein the classifier comprises a rentable domain classifier and a non-rentable domain classifier.

16. The system of claim 15, wherein the rentable domain classifier is used to classify a candidate website in response to determining that a corresponding domain is a rentable domain.

17. The system of claim 15, wherein the non-rentable domain classifier is used to classify a candidate website in response to determining that a corresponding domain is a non-rentable domain.

18. The system of claim 15, wherein the rentable domain classifier and the non-rentable domain classifiers comprise machine learning models that are trained using different sets of features.

19. The system of claim 1, wherein the classifier is configured to predict whether a candidate domain is likely to become malicious within a predetermined period of time.

20. The system of claim 19, wherein the classifier assigns a risk score based on a likelihood that the candidate domain will become malicious within the predetermined period of time.

21. The system of claim 20, wherein the risk score is based at least in part on a machine learning-based computation that incorporates information from multiple data sources.

22. The system of claim 1, wherein the classifier comprises one or more of (i) an inline rentable domain classifier, (ii) an offline rentable domain classifier, (iii) an inline non-rentable domain classifier, and (iv) an offline non-rentable domain classifier.

23. The system of claim 1, wherein the classifier is an offline classifier that performs classifications offline that is asynchronous to an interception of network traffic.

24. The system of claim 1, wherein the classifier is an inline classifier that generates classifications contemporaneous with an interception and handling of network traffic.

25. The system of claim 24, wherein the inline classifier generates the classifications in less than 100 ms.

26. The system of claim 1, wherein the one or more processors are further configured to:
obtain a predicted classification for a candidate website from the classifier;
perform a post-filtering to be performed with respect to the predicted classification to determine whether the predicted classification is a false positive classification; and
determining a classification for the candidate website based at least in part on a result of post-filtering the predicted classification.

27. A method, comprising:
identifying a subset of higher risk websites, wherein the higher risk websites are at risk for potential malware injection or modification; and
in response to identifying the subset of higher risk websites, performing an active measure based at least in part on the identified subset of higher risk websites.

28. A computer program product embodied in a non-transitory computer readable medium and comprising computer instructions for:
identifying a subset of higher risk websites, wherein the higher risk websites are at risk for potential malware injection or modification; and
in response to identifying the subset of higher risk websites, performing an active measure based at least in part on the identified subset of higher risk websites.

29. A system, comprising:
one or more processors configured to:
collect a set of features for a set of training sample websites, the set of training sample websites comprising a subset of benign or low risk domains, and a subset of high risk domains; and
perform a machine learning process to generate a domain classifier based at least in part on the set of features for the set of training sample websites;
deploy the domain classifier in a system to perform detection of malicious domains; and
a memory coupled to the one or more processors and configured to provide the one or more processors with instructions.

30. The system of claim 29, wherein the set of features are generated based at least in part one or more of crawled website content, lexical data, registration historical risk scores, pDNS data, and Virus Total reports.

31. The system of claim 29, wherein the machine learning process comprises one or more of a random forest technique or an XGBoost technique.
